(19) United States
(12) Patent Application Publication
(10) Pub. No.: US 2025/0279821 A1
(43) Pub. Date: Sep. 4, 2025

(54) WIRELESS SENSING FOR TRANSMISSIVE AND HYBRID RECONFIGURABLE INTELLIGENT SURFACES

(71) Applicant: QUALCOMM Incorporated, San Diego, CA (US)

(72) Inventors: Min HUANG, Beijing (CN); Jing DAI, Beijing (CN); Hao XU, Beijing (CN)

(21) Appl. No.: 19/128,913

(22) PCT Filed: Dec. 22, 2022
(86) PCT No.: PCT/CN2022/140990

§ 371 Date: May 9, 2025

(51) Int. Cl. H04B 7/06; H04B 7/04; H04W 8/22; H04W 52/42

(52) U.S. Cl. CPC H04B 7/06956; H04B 7/04013; H04W 8/22; H04W 52/42

(57) ABSTRACT

A wireless device may transmit, for a network node, a capability report including (1) a first indication of a first transmissive coefficient value, (2) a second indication of a sensing capability, or (3) a third indication of a transmissive and reflective capability. The wireless device may receive, from the network node, a transmissive signal configuration or a transmissive and reflective configuration based on the capability report. The wireless device may select, based on the transmissive signal configuration or the transmissive and reflective configuration: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

### TECHNICAL FIELD

The present disclosure relates generally to communication systems, and more particularly, to a wireless sensing system using a reconfigurable intelligent surface (RIS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a wireless device are provided. The wireless device may be a reconfigurable intelligent surface (RIS). The apparatus may transmit, for a network node, a capability report including at least one of: (1) a first indication of a first transmissive coefficient value, (2) a second indication of a sensing capability, or (3) a third indication of a transmissive and reflective capability. The apparatus may receive, from the network node, at least one of a transmissive signal configuration or a transmissive and reflective configuration based on the capability report. The apparatus may select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

In an aspect of the disclosure, a method, a computer-readable medium, and an apparatus at a network node are provided. The apparatus may receive, from a wireless device, a capability report including at least one of: (1) a first indication of a transmissive coefficient value, (2) a second indication of a sensing capability, or (3) a third indication of a transmissive and reflective capability. The apparatus may transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of sensing based on measurements of sensing signals reflected off of a target object, in accordance with various aspects of the present disclosure.

FIG. 5 is a diagram illustrating an example of a wireless device configured to reflect, transmit, or reflect and transmit one or more signals from a network node, in accordance with various aspects of the present disclosure.

FIG. 6A is a diagram illustrating an example of meta-elements of a wireless device configured to transmit a signal from a network node to a UE, in accordance with various aspects of the present disclosure.

FIG. 6B is a diagram illustrating another example of meta-elements of a wireless device configured to transmit a signal from a network node to a UE, in accordance with various aspects of the present disclosure.

FIG. 7A is a diagram illustrating an example of a wireless device configured to assist a network node in performing monostatic sensing of a target object, in accordance with various aspects of the present disclosure.

FIG. 7B is a diagram illustrating an example of a wireless device configured to assist a network node in performing bistatic sensing of a target object, in accordance with various aspects of the present disclosure.

FIG. 7C is a diagram illustrating an example of a wireless device configured to assist a network node in performing monostatic or bistatic sensing of a target object using a plurality of differently configured surfaces, in accordance with various aspects of the present disclosure.

FIG. 8A is a diagram illustrating another example of a wireless device configured to assist a network node in performing monostatic sensing of a target object using a plurality of differently configured surfaces, in accordance with various aspects of the present disclosure.

FIG. 8B is a diagram illustrating another example of a wireless device configured to assist a network node in performing bistatic sensing of a target object using a plurality of differently configured surfaces, in accordance with various aspects of the present disclosure.

FIG. 9A is a diagram illustrating another example of a wireless device configured to assist a network node in performing monostatic sensing of a target object, in accordance with various aspects of the present disclosure.

FIG. 9B is a diagram illustrating another example of a wireless device configured to assist a network node in performing monostatic sensing of a target object, in accordance with various aspects of the present disclosure.

FIG. 10A is a diagram illustrating an example of a wireless device configured to assist a network node in performing monostatic sensing of a plurality of target objects using both transmissive and reflective properties of its meta-elements, in accordance with various aspects of the present disclosure.

FIG. 10B is a diagram illustrating an example of a wireless device configured to assist a network node in performing monostatic sensing of a plurality of target objects using both transmissive and reflective properties of its meta-elements with a plurality of differently configured surfaces, in accordance with various aspects of the present disclosure.

FIG. 11 is a connection flow diagram illustrating an example of communications between a network node and a wireless device configured to assist a network node in performing sensing on a target object, in accordance with various aspects of the present disclosure.

FIG. 12 is a flowchart of a method of wireless communication.

FIG. 13 is another flowchart of a method of wireless communication.

FIG. 14 is a diagram illustrating an example of a hardware implementation for an example network entity.

FIG. 15 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

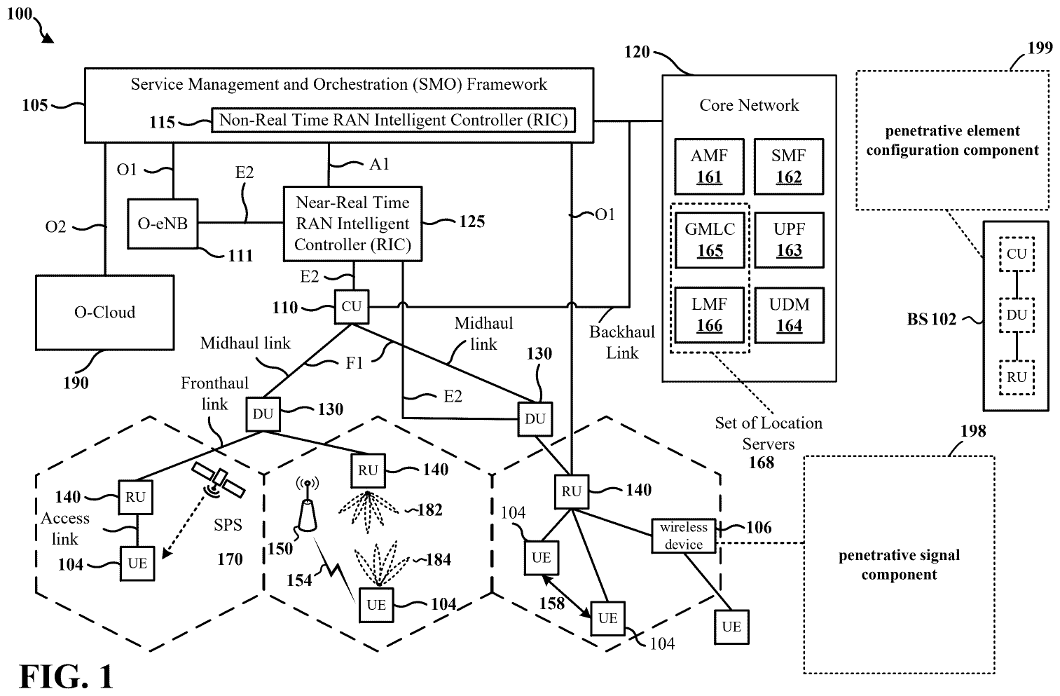

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A wireless device 106 may be a meta-surface configured to receive an incident wave from another wireless device, such as a base station 102, an RU 140 of a base station 102, or a UE 104. The wireless device 106 may be a reconfigurable intelligent surface (RIS). The wireless device 106 may be configured to redirect a transmission through the wireless device 106 (e.g., generate a transmissive signal from a signal received by the wireless device 106) towards a desired direction or reflect a transmission off of a surface of the wireless device 106 (e.g., generate a reflective signal from a signal received by the wireless device 106), towards a desired direction, or redirect a portion of the incident wave and reflect another portion of the incident wave.

Referring again to FIG. 1, in certain aspects, the wireless device 106 may have a penetrative signal component 198 configured to transmit, for a network node, a capability report including at least one of: (1) a first indication of a first transmissive coefficient value, (2) a second indication of a sensing capability, or (3) a third indication of a transmissive and reflective capability. The penetrative signal component 198 may be configured to receive, from the network node, at least one of a transmissive signal configuration or a transmissive and reflective configuration based on the capability report. The penetrative signal component 198 may be configured to select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. In certain aspects, the base station 102 may have a penetrative element configuration component 199 configured to receive, from a wireless device, a capability report including at least one of: (1) a first indication of a transmissive coefficient value, (2) a second indication of a sensing capability, or (3) a third indication of a transmissive and reflective capability. The penetrative element configuration component 199 may be configured to transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. Although the following description may be focused on RIS devices, the concepts described herein may be applicable to any wireless device that may be configured to redirect and/or reflect signals off of a surface of the device based on a configuration received from another wireless device. Although the following description may be focused on 5G NR, the concepts described herein may be applicable to other similar areas, such as LTE, LTE-A, CDMA, GSM, and other wireless technologies.

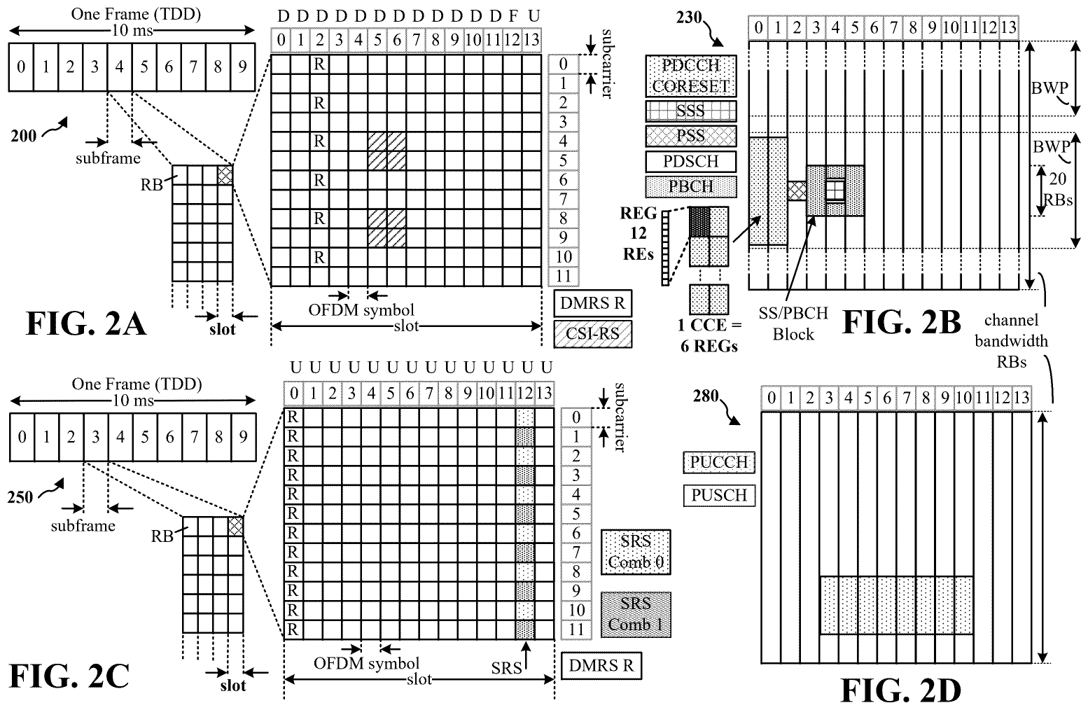

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

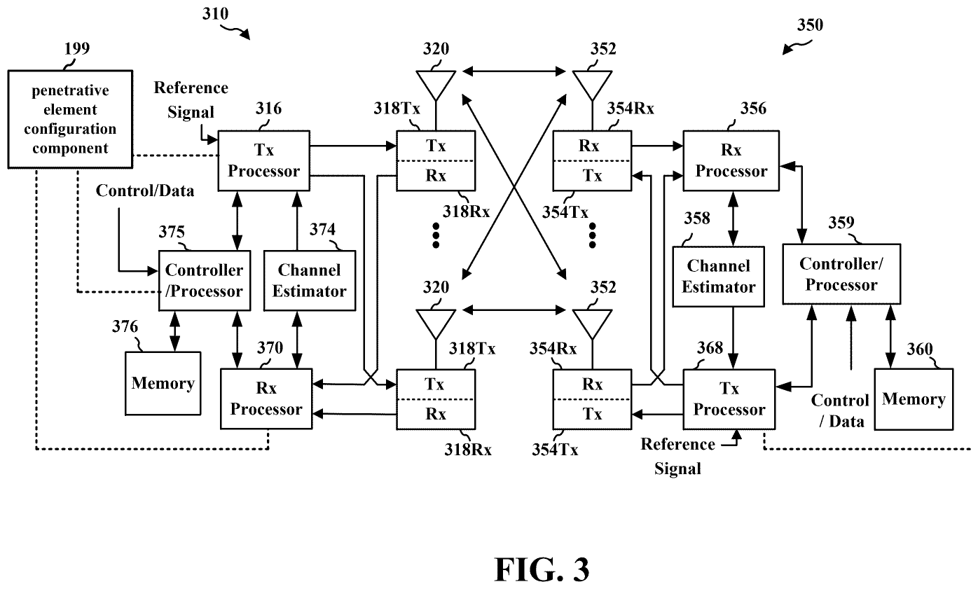

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 316, the Rx processor 370, and the controller/processor 375 may be configured to perform aspects in connection with the penetrative element configuration component 199 of FIG. 1.

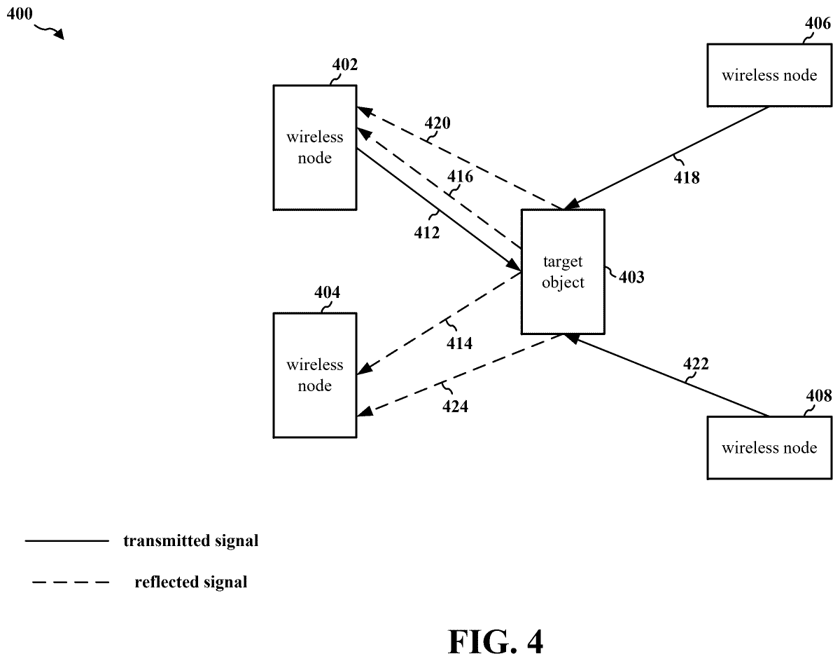

FIG. 4 is a diagram 400 illustrating an example of sensing based on sensing signal measurements. In one aspect, the wireless node 402 may perform monostatic sensing, where the wireless node 402 may transmit a set of sensing signals 412 at the target object 403, the target object 403 may reflect the set of sensing signals 412 as the reflected set of sensing signals 416 at the wireless node 402, and the wireless node 402 may measure the reflected set of sensing signals 416 from the target object 403. In another aspect, the wireless node 402 and the wireless node 404 may perform bistatic sensing, where the wireless node 402 may transmit a set of sensing signals 412 at the target object 403, the target object 403 may reflect the set of sensing signals 412 as the reflected set of sensing signals 414 at the wireless node 404, and the wireless node 404 may measure the reflected set of sensing signals 414 from the target object 403. In another aspect the wireless node 402 and the wireless node 406 may perform multi-static sensing, where in addition to the wireless node 402 measuring the reflected set of sensing signals 416 from the target object 403 using monostatic sensing, the wireless node 406 may transmit a set of sensing signals 418 at the target object 403, the target object 403 may reflect the set of sensing signals 418 as the reflected set of sensing signals 420 at the wireless node 402, and the wireless node 402 may measure the reflected set of sensing signals 420 from the target object 403. In another aspect the wireless node 402, the wireless node 404, and the wireless node 408 may perform multi-static sensing, where in addition to the wireless node 404 measuring the reflected set of sensing signals 414 from the target object 403 using bistatic sensing, the wireless node 408 may transmit a set of sensing signals 422 at the target object 403, the target object 403 may reflect the set of sensing signals 422 as the reflected set of sensing signals 424 at the wireless node 404, and the wireless node 404 may measure the reflected set of sensing signals 424 from the target object 403. Each wireless node may be any wireless device configured to transmit or receive wireless signals, such as UEs, network nodes, TRPs, or base stations. For example, the wireless node 402 may be a network node configured to transmit the set of sensing signals 412 at the target object 403 and measure the reflected set of sensing signals 416 from the target object 403. In another example, the wireless node 402 may be a network node configured to transmit the set of sensing signals 412 at the target object 403, and the wireless node 404 may be a UE configured to measure the reflected set of sensing signals 414 from the target object 403.

The wireless node 402 may conduct one or more sensing measurements on the reflected set of sensing signals 416 and/or the reflected set of sensing signals 420. In one aspect, the wireless node 402 may calculate a distance or a range between the wireless node 402 and the target object 403 based on a round trip time (RTT) between when the wireless node 402 transmits the set of sensing signals 412 and when the wireless node 402 receives the reflected set of sensing signals 416. In one aspect, the wireless node 402 may calculate a distance or a range that the set of sensing signals 418 and the reflected set of sensing signals 420 travels based on a time between when the wireless node 406 transmits the set of sensing signals 418 and when the wireless node 402 receives the reflected set of sensing signals 420. In one aspect, the wireless node 402 may calculate a location of the target object 403 based on a plurality or range or distance measurements, for example via triangulation using known positions of the wireless nodes 402 and 406 and the calculated range or distance measurements. In one aspect, the wireless node 402 may calculate a velocity of the target object 403 based on a first calculated location of the target object 403 based on the reflected set of sensing signals 416 and/or the reflected set of sensing signals 420 measured at a first time, and a second calculated location of the target object 403 based on the reflected set of sensing signals 416 and/or the reflected set of sensing signals 420 measured at a second time. In one aspect, the wireless node 402 may calculate an AoA of the reflected set of sensing signals 416 and/or an AoD of the set of sensing signals 412 based on a plurality of ports that transmitted the set of sensing signals 412 and a plurality of ports that received the reflected set of sensing signals 416. In one aspect, the wireless node 402 may calculate an AoA of the reflected set of sensing signals 420 and/or an AoD of the set of sensing signals 418 based on a plurality of ports that transmitted the set of sensing signals 418 and a plurality of ports that received the reflected set of sensing signals 420.

Similarly, the wireless node 404 may conduct one or more sensing measurements on the reflected set of sensing signals 414 and/or the reflected set of sensing signals 424. In one aspect, the wireless node 404 may calculate a distance or a range that the set of sensing signals 412 and the reflected set of sensing signals 414 travels based on a on a time between when the wireless node 402 transmits the set of sensing signals 412 and when the wireless node 404 receives the reflected set of sensing signals 414. In one aspect, the wireless node 404 may calculate a distance or a range that the set of sensing signals 422 and the reflected set of sensing signals 424 travels based on a time between when the wireless node 408 transmits the set of sensing signals 422 and when the wireless node 404 receives the reflected set of sensing signals 424. In one aspect, the wireless node 404 may calculate a location of the target object 403 based on a plurality or range or distance measurements, for example via triangulation using the known positions of wireless nodes 402, 404, and 408, and the calculated range or distance measurements. In one aspect, the wireless node 404 may calculate a velocity of the target object 403 based on a first calculated location of the target object 403 based on the reflected set of sensing signals 414 and/or the reflected set of sensing signals 424 measured at a first time, and a second calculated location of the target object 403 based on the reflected set of sensing signals 414 and/or the reflected set of sensing signals 424 measured at a second time. In one aspect, the wireless node 404 may calculate an AoA of the reflected set of sensing signals 414 and/or an AoD of the set of sensing signals 412 based on a plurality of ports that transmitted the set of sensing signals 412 and a plurality of ports that received the reflected set of sensing signals 414. In one aspect, the wireless node 404 may calculate an AoA of the reflected set of sensing signals 424 and/or an AoD of the set of sensing signals 422 based on a plurality of ports that transmitted the set of sensing signals 422 and a plurality of ports that received the reflected set of sensing signals 424.

A network node or a UE configured to perform measurements on a set of reflected sensing signals may be configured to transmit a sensing signal report to a sensing server (e.g., an LMF) that coordinates a plurality of wireless nodes to perform sensing on a target object. In order to perform Doppler estimates or velocity estimates of a target object, such as the target object 403 in FIG. 4, or of a UE, such as the UE 104 in FIG. 1, the receiver wireless node may be configured to measure a reflected set of sensing signals at multiple points of time.

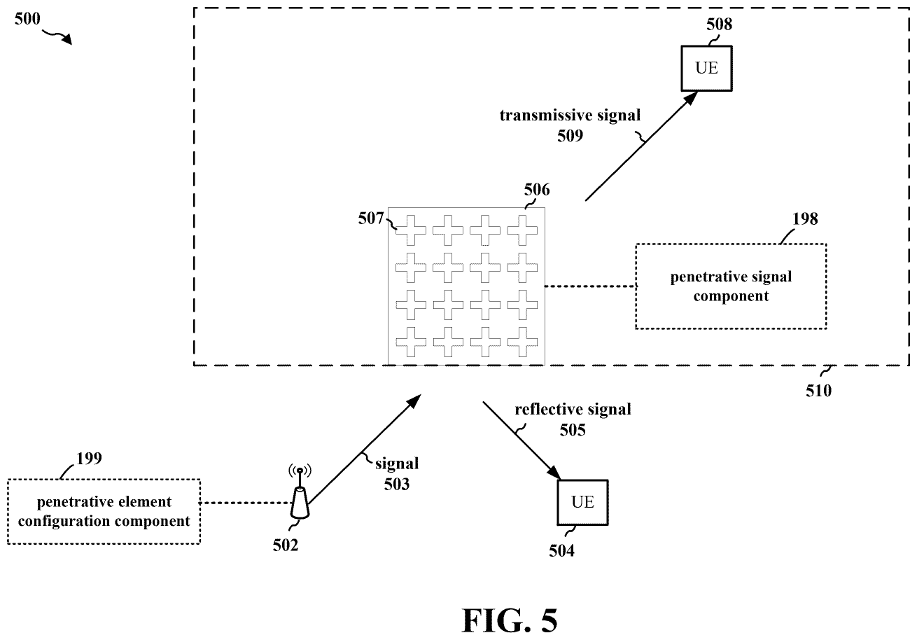

FIG. 5 is a diagram 500 illustrating an example of a wireless device 506 configured to receive a signal 503 from a network node 502. The wireless device 506 may be, for example, a window of an enclosed space 510 (e.g., a building, a wall, or a vehicle) having walls or panels that block wireless signals, but the wireless device 506 may redirect and/or reflect wireless signals. Using the meta-elements 507 at the surface of the wireless device 506, the wireless device 506 may redirect the signal 503 as the transmissive signal 509 towards the UE 508. The UE 508 may then measure the transmissive signal 509 to perform sensing on the wireless device 506. In some aspects, the wireless device 506 may redirect the transmissive signal 509 towards a target object, which then may reflect the transmissive signal to a wireless device, such as a network node or a UE, for sensing the target object. Using the meta-elements 507 at the surface of the wireless device 506, the wireless device 506 may reflect the signal 503 as the reflective signal 505 towards the UE 504. The UE 504 may then measure the reflective signal 505 to perform sensing on the wireless device 506. In some aspects, the wireless device 506 may reflect the reflective signal 505 towards a target object, which then may reflect the reflective signal to a wireless device, such as a network node or a UE, for sensing the target object. One or more of the meta-elements 507 of a meta-surface of the wireless device 506 may have a transmissive mode, a reflective mode, or a hybrid transmissive and reflective mode.

When a meta-element 507 is switched to a reflection mode, the meta-element 507 may be configured to reflect the signal 503 to a desired direction. In other words, the wireless device 506 may reflect the signal 503 to an object on the same side of the network node 502. The configuration of one or more reflective elements, such as a meta-element 507, may be used to aim a signal 503 in a desired direction. For example, one or more reflection coefficients of the meta-element 507 may be changed to alter a direction that the reflective signal 505 is centered upon. For example, a first coefficient may be altered to change an amplitude of the reflective signal 505 from the meta-element 507 and a second coefficient may be altered to shift a phase of the reflective signal 505 from the meta-element 507. The configuration of the meta-element 507 of the wireless device 506 may depend on the knowledge of the direction of the incident wave of the signal 503. In other words, the accuracy of where a meta-element 507 centers or aims the reflective signal 505 may be increased using information about the direction that the signal 503 approaches the meta-element 507 from, or an AoA of the signal 503 relative to the meta-element 507. In some aspects, the network node 502 may transmit a configuration to the wireless device 506 to assist the wireless device 506 in accurately aiming the reflective signal 505.

Similarly, when a meta-element 507 is switched to a transmissive mode, the meta-element 507 may be configured to redirect the signal 503 to a desired direction. In other words, the wireless device 506 may redirect the signal 503 to an object on the opposite side of the network node 502 (i.e., the signal 503 may penetrate the enclosed space 510 via the wireless device 506). The configuration of one or more redirecting elements, such as a meta-element 507, may be used to redirect a signal 503 towards a desired direction, similar to a prism. For example, one or more redirection coefficients of the meta-element 507 may be changed to alter a direction that the transmissive signal 509 is centered upon. For example, a first coefficient may be altered to change an amplitude of the transmissive signal 509 via the meta-element 507 and a second coefficient may be altered to shift a phase of the transmissive signal 509 via the meta-element 507. The configuration of the meta-element 507 of the wireless device 506 may depend on the knowledge of the direction of the incident wave of the signal 503. In other words, the accuracy of where a meta-element 507 centers or aims the transmissive signal 509 may be increased using information about the direction that the signal 503 approaches the meta-element 507 from, or an AoA of the signal 503 relative to the meta-element 507. In some aspects, the network node 502 may transmit a configuration to the wireless device 506 to assist the wireless device 506 in accurately aiming the transmissive signal 509.

In some aspects, the wireless device 506 may be configured to redirect a signal 503 in any direction relative to the meta-element 507 by either redirecting the signal 503 as a transmissive signal 509 or by reflecting the signal 503 as a reflective signal 505.

In some aspects, the wireless device 506 may be configured to activate both a transmissive mode and a reflective mode. In other words, the wireless device 506 may have a dual function of reflection and transmission of the signal 503 to a first object on the same side of the network node 502 and to a second object on the opposite side of the network node 502, respectively. For example, the wireless device 506 may be configured to reflect a portion of the signal 503 as the reflective signal 505 towards the UE 504, and may be configured to redirect a portion of the signal 503 towards the UE 508. In other words, one or more meta-elements 507 of the wireless device 506 may be configured to have both reflective and transmissive capabilities such that the meta-surface of the wireless device 506 may reflect one portion of an impinging signal in a controllable manner, while simultaneously redirecting another portion of the impinging signal in a controllable manner. The wireless device 506 may be described as having a hybrid transmissive and reflective mode. In some aspects, one or more meta-elements 507 may be switched to a transmissive mode while one or more other meta-elements may be switched to a reflective mode.

The network node 502 may have a penetrative element configuration component 199. The penetrative element configuration component 199 may be configured to receive, from a wireless device, a capability report including at least one of: (1) a first indication of a transmissive coefficient value, (2) a second indication of a sensing capability, or (3) a third indication of a transmissive and reflective capability. The penetrative element configuration component 199 may be configured to transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

The wireless device 506 may have a penetrative signal component 198. The penetrative signal component 198 may be configured to transmit, for a network node, a capability report including at least one of: (1) a first indication of a first transmissive coefficient value, (2) a second indication of a sensing capability, or (3) a third indication of a transmissive and reflective capability. The penetrative signal component 198 may be configured to receive, from the network node, at least one of a transmissive signal configuration or a transmissive and reflective configuration based on the capability report. The penetrative signal component 198 may be configured to select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

As discussed supra, the penetrative signal component 198 may be configured to transmit, for a network node, a capability report including at least one of: (1) a first indication of a first transmissive coefficient value, (2) a second indication of a sensing capability, or (3) a third indication of a transmissive and reflective capability. The penetrative signal component 198 may be configured to receive, from the network node, at least one of a transmissive signal configuration or a transmissive and reflective configuration based on the capability report. The penetrative signal component 198 may be configured to select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The penetrative signal component 198 may be within a processor of the wireless device 506. The penetrative signal component 198 may be one or more hardware components specifically configured to carry out the stated processes/algorithm, implemented by one or more processors configured to perform the stated processes/algorithm, stored within a computer-readable medium for implementation by one or more processors, or some combination thereof. In one configuration, the wireless device 506 may include means for transmitting, for a network node, a capability report including at least one of: (1) a first indication of a first transmissive coefficient value, (2) a second indication of a sensing capability, or (3) a third indication of a transmissive and reflective capability. The wireless device 506 may include means for receiving, from the network node, at least one of a transmissive signal configuration or a transmissive and reflective configuration based on the capability report. The wireless device 506 may include means for selecting, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The capability report may include a fourth indication of whether the first transmissive coefficient value is associated with monodirectional transmission or bidirectional transmission. The capability report may include a fourth indication of a bidirectional transmission capability. The first transmissive coefficient value may be associated with the first transmission direction. The capability report may further include a fourth indication of a second transmissive coefficient value associated with the second transmission direction. The first transmissive coefficient value may be different from the second transmissive coefficient value. At least one of the transmissive signal configuration or the transmissive and reflective configuration may include a fifth indication of the first section of the surface of the wireless device for the first transmission direction and a sixth indication of the second section of the surface of the wireless device for the second transmission direction. The wireless device 506 may include means for selecting the first section of the surface of the wireless device for the first transmission direction and the second section of the surface of the wireless device for the second transmission direction based on the fifth indication and the sixth indication of at least one of the transmissive signal configuration or the transmissive and reflective configuration. The first transmissive coefficient value may be associated with the first transmission direction and the second transmission direction. At least one of the transmissive signal configuration or the transmissive and reflective configuration may include a fourth indication of an entire surface area of the surface of the wireless device for the first transmission direction and the second transmission direction. The wireless device 506 may include means for selecting the entire surface area of the surface of the wireless device as the first section of the surface of the wireless device for the first transmission direction and as the second section of the surface of the wireless device for the second transmission direction based on the fourth indication of at least one of the transmissive signal configuration or the transmissive and reflective configuration. At least one of the transmissive signal configuration or the transmissive and reflective configuration may include a fourth indication of an entire surface area of the surface of the wireless device for the first transmission direction. The wireless device 506 may include means for selecting the entire surface area of the surface of the wireless device as the first section of the surface of the wireless device for the first transmission direction based on the fourth indication of at least one of the transmissive signal configuration or the transmissive and reflective configuration. At least one of the transmissive signal configuration or the transmissive and reflective configuration may further include a fifth indication of the first transmission direction. The wireless device 506 may include means for selecting the first section of the surface of the wireless device for the first transmission direction based on the fifth indication of at least one of the transmissive signal configuration or the transmissive and reflective configuration. At least one of the transmissive signal configuration or the transmissive and reflective configuration may include a fourth indication of at least one of an incident angle or an incident distance for the first section of the surface of the wireless device for the first transmission direction. At least one of the transmissive signal configuration or the transmissive and reflective configuration may include a fifth indication of at least one of a transmissive angle or a transmissive distance for the second section of the surface of the wireless device. The wireless device 506 may include means for configuring a first transmissive coefficient of a first set of meta-elements of the first section of the surface of the wireless device based on the fourth indication of at least one of the incident angle or the incident distance. The wireless device 506 may include means for configuring a second transmissive coefficient of a second set of meta-elements of the second section of the surface of the wireless device based on the fifth indication of at least one of the transmissive angle or the transmissive distance. The incident angle may be equal to the transmissive angle. At least one of the transmissive signal configuration or the transmissive and reflective configuration may further include a sixth indication of at least one of a minimum transmissive angle or a maximum transmissive angle and a seventh indication of at least one of a minimum incident angle or a maximum incident angle. The wireless device 506 may include means for configuring the first transmissive coefficient of the first set of meta-elements of the first section of the surface of the wireless device to perform beam sweeping based on at least one of the minimum transmissive angle or the maximum transmissive angle. The wireless device 506 may include means for configuring the second transmissive coefficient of the second set of meta-elements of the second section of the surface of the wireless device to perform the beam sweeping based on at least one of the minimum incident angle or the maximum incident angle. At least one of the transmissive signal configuration or the transmissive and reflective configuration may include a first beamforming gain factor. The wireless device 506 may include means for applying the first beamforming gain factor to at least one meta-element of the surface of the wireless device. The wireless device 506 may include means for receiving, from the network node 502, a second transmissive signal configuration or a second transmissive and reflective configuration including a second beamforming gain factor. The wireless device 506 may include means for applying the second beamforming gain factor to the at least one meta-element of the surface of the wireless device. The wireless device 506 may include means for applying the second beamforming gain factor and the first beamforming gain factor to the at least one meta-element of the surface of the wireless device. The third indication of the transmissive and reflective capability may indicate that a power split between transmission and reflection associated with a set of meta-elements of the surface of the wireless device is fixed. The third indication of the transmissive and reflective capability may indicate that a power split between transmission and reflection associated with meta-elements of the surface of the wireless device is configurable. The transmissive and reflective configuration may include a fourth indication of a power split ratio between the transmission and the reflection. The wireless device 506 may include means for configuring a set of meta-elements of the surface of the wireless device based on the fourth indication of the power split ratio between the transmission and the reflection. The third section and the fourth section may include an overlapping section of the surface of the wireless device. The wireless device 506 may include means for selecting the third section of the surface of the wireless device for the transmissive mode by selecting a first set of time periods for the overlapping section of the surface of the wireless device. The wireless device 506 may include means for selecting the fourth section of the surface of the wireless device for the reflective mode by selecting a second set of time periods for the overlapping section of the surface of the wireless device. The first set of time periods and the second set of time periods may be non-overlapping. The wireless device 506 may include means for configuring at least one of a transmissive coefficient for the third section of the surface or a reflective coefficient for the fourth section of the surface based on the transmissive and reflective configuration. The wireless device 506 may include a RIS. The first section and the second section may overlap. The means may be the penetrative signal component 198 of the wireless device 506 configured to perform the functions recited by the means.

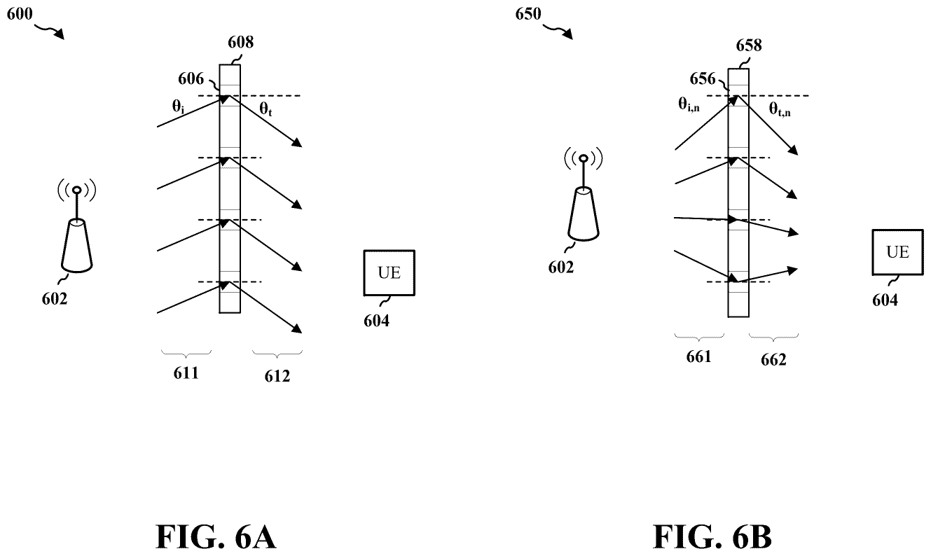

FIG. 6A is a diagram 600 illustrating an example of meta-elements 606 of a wireless device 608 configured to transmit a set of signals 611 from a network node 602 to a UE 604 as the transmissive signals 612. The network node 602 and the UE 604 may both be in the far field of the surface of the wireless device 608 including the multiple meta-elements 606. When a signal is transmitted from the network node 602 to the wireless device 608 at the incident angle θᵢ, the equivalent channel response value of the nth element of the wireless device 608 at a transmissive angle θₜ may be represented by

$${h}_{n} = {e}^{j \frac{2 π {d}_{n}}{λ} ( sin {θ}_{i} + sin {θ}_{t} )} \times {α}_{n} {e}^{j {φ}_{n}} .$$

αₙe^{jφ}^{ₙ} may be the transmissive coefficient of the meta-element n, for example the meta-element 606 may be the first meta-element of a total of N elements.

dₙ may be the distance between the nth meta-element to the first meta-element.

j may be a complex value symbol.

λ may be the wavelength of the signal reflected off of the meta-element n.

αₙ may be an amplitude of a reflection coefficient at the nth meta-element. φₙ may be a phase of the transmissive coefficient at the nth meta-element.

The overall equivalent channel response value of all of the elements of the wireless device 608 at the transmissive angle θₜ may be represented by:

$$h = {\sum }_{n = 1}^{N} {h}_{n} = {\sum }_{n = 1}^{N} {e}^{j \frac{2 π {d}_{n}}{λ} ( sin {θ}_{i} + sin {θ}_{t} )} \times {α}_{n} {e}^{j {φ}_{n}}$$

If the transmissive coefficient satisfies αₙ≡α, then the value of on may be estimated as

$${φ}_{n} = - \frac{2 π {d}_{n}}{λ} ( sin {θ}_{i} + sin {θ}_{t} )$$

The transmissive beam may point to the direction θₜ.

The coefficient amplitude and phase values of each of the meta-elements 606 of the wireless device 608 may be obtained from a limited set {(α₁, ϕ₁), (α₂, ϕ₂), . . . , (α_{M}, ϕ_{M})} by different configurations, where αₘ may be the amplitude of the mth candidate transmissive coefficient and ϕₘ may be the phase of the mth candidate transmissive coefficient. In other words, the actual beam shape may deviate from the ideal estimated beam direction θₜ. The larger the number of meta-elements 606 of the wireless device 608, the closer the actual beam shape may be to the ideal beam, which may increase the accuracy of the estimated beam direction Ot.

FIG. 6B is a diagram 650 illustrating another example of meta-elements 656 of a wireless device 658 configured to transmit a set of signals 661 from a network node 602 to a UE 604 as the transmissive signals 662. The network node 602 and the UE 604 may both be in the near field of the surface of the wireless device 658 including the multiple meta-elements 656. As a result, the incident angle θ_{i,n} and the transmissive angle θ_{t,n} at each meta-element n may be different than the incident angles and transmissive angles associated with at least one other meta-element of the wireless device 658. The incident angle θ_{i,n} and the transmissive angle θ_{t,n} at each meta-element n may be calculated based on the meta-element position, the orientation of the surface of the wireless device 658, and the position of the Tx beam and the Rx beam relative to the surface of the wireless device 658.

The selected coefficient amplitude αₙ and phase ϕₙ of each meta-element n may be related to the incident angle θ_{i,n} and the transmissive angle θ_{t,n}, which may depend on both the direction and the distance of the network node 602 and the UE 604 relative to the wireless device 658.

When a signal is transmitted towards a meta-element n at an incident angle θ_{i,n}, the equivalent channel response value of the nth element of the wireless device 658 may, again, be represented by

$${h}_{n} = {e}^{j \frac{2 π {d}_{n}}{λ} ( sin {θ}_{i} + sin {θ}_{t} )} \times {α}_{n} {e}^{j {φ}_{n}} .$$

Similarly, the overall equivalent channel response value of all of the elements of the wireless device 658 at all of the transmissive angles θₜ may be represented by:

$$h = {\sum }_{n = 1}^{N} {h}_{n} = {\sum }_{n = 1}^{N} {e}^{j \frac{2 π {d}_{n}}{λ} ( sin {θ}_{i} + sin {θ}_{t} )} \times {α}_{n} {e}^{j {φ}_{n}}$$

Similarly, if the transmissive coefficient satisfies αₙ≡α, then the value of φₙ may be estimated as

$${φ}_{n} = - \frac{2 π {d}_{n}}{λ} ( sin {θ}_{i} + sin {θ}_{t} )$$

The transmissive beam may point generally to the direction of all of the transmissive angles {θ_{t,n}}.

The wireless device 658 may determine the selected coefficient amplitude an and phase ϕₙ of each meta-element n by selecting one available configuration whose amplitude and phase are closest to the theoretical values.

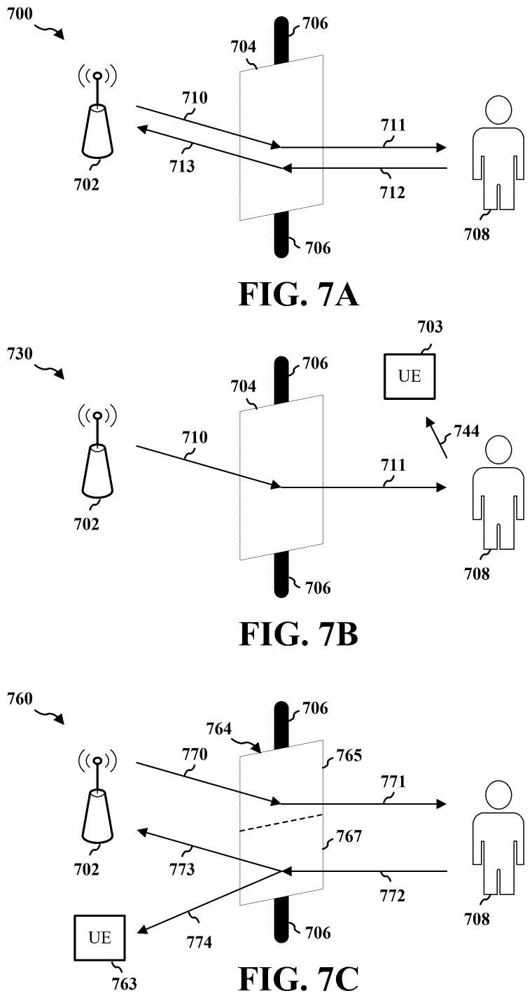

FIG. 7A is a diagram 700 illustrating an example of a wireless device 704 configured to assist a network node 702 in performing monostatic sensing of a target object 708. The wireless device 704 may provide a window between a blocking object 706 that does not allow wireless signals from the network node 702 to penetrate. In other words, the wireless device 704 may be a transmissive object that may be used for a radar (e.g., a network node or a UE) outside an enclosed space to sense an object within the enclosed space. Such a wireless device may be used for a plurality of purposes, such as indoor security (e.g., intruder detection), safety (e.g., monitoring a child within an enclosed space), behavior detection (e.g., determining if a person is walking, running, sitting, or standing), or status detection (e.g., determining if a room is full or empty). If the wireless device 704 is set to a reflective mode, the network node 702 may be relatively far from the boresight direction. The incident angle θᵢ, θ_{i,n}, may be much larger than zero in such aspects. If the wireless device 704 is set to a transmissive mode, the network node 702 may be within or near the boresight direction. The incident angle θᵢ, θ_{i,n}, may be equal to or slightly larger than zero in such aspects. Since the coefficient gain of each meta-element may be proportional to cos θ, the transmissive signal transmitted by a wireless device set to a transmissive mode may have more meta-element radiation power than a reflective signal reflected by a wireless device set to a reflective mode.

In some aspects, the wireless device 704 may be configured to have transmissive coefficient values for two transmission (penetration) directions that are identical. In other aspects, the wireless device 704 may be configured to have transmissive coefficient values that are different. The network node 702 may be configured to receive such information from the wireless device 704 (e.g., whether the penetration direction is relevant or irrelevant to the transmissive coefficient value) in order to configure the wireless device 704 correctly.

In some aspects, the transmissive beamforming gain of the wireless device 704 may depend upon the number of meta-elements at the surface of the wireless device 704 and the beam width of the sensing beam transmitted by the wireless device transmitting the sensing signal. The wireless device 704 may be configured to adjust its transmissive beamforming gain by controlling the number of active meta-elements and the beam width of the sensing beam. For example, the higher the beamforming gain, the larger the received signal strength may be. In another example, the larger the beam width, the smaller amount of radio resources may be. Thus, the network node 702 may be configured to control whether and how much to adjust the transmissive beamforming gain.

In some aspects, the wireless device 704 may be configured to simultaneously redirect a signal and reflect a signal, for example by redirecting a portion of a signal and reflecting a portion of the signal. The network node 702 may be configured to manage the surface split, incident angles, transmissive angles, reflective angles, and proper power split ratio between transmission and reflection.

The wireless device 704 may be configured to transmit a capability report message to the network node 702 indicating its capability of bidirectional transmission. For example, the capability report may indicate whether an element of the wireless device may be configured to reflect a beam in a direction, redirect a beam in a direction, or reflect a portion of a beam in one direction and redirect another portion of the beam in another direction. The capability report may also indicate whether the wireless device 704 may configure one element to reflect/redirect a beam in one direction, and another element to reflect/redirect a beam in an opposing direction (e.g., whether the surface may be configured for monodirectional reflection/redirection or whether the surface may be configured for bidirectional reflection/redirection.) The wireless device 704 may indicate for each meta-element configuration (e.g., electrical voltage), whether the transmissive coefficient values for two transmission directions are identical or different. In some aspects, the wireless device 704 may also report whether it may support simultaneous bidirectional transmission. Such a report may be used in aspects where simultaneous bidirectional transmission is not a standard capability.

In response to receiving the report, the network node 702 may transmit a message to the wireless device 704 to configure transmission directions and surface split based on a sensing type. If the sensing signal transmitter and the receiver are on the same side of the wireless device 704, the network node 702 may act as a monostatic radar. If, for a certain configuration (e.g., an electrical voltage), the meta-element transmissive coefficient value is irrelevant to the incident angle, the network node 702 may configure the wireless device 704 to use the entire meta-surface of the wireless device 704 (i.e., all of its meta-elements) for the two transmission directions. In such an aspect, the network node 702 may transmit a sensing signal 710 to the wireless device 704, the wireless device may redirect the sensing signal 710 as the transmissive signal 711 at the target object 708, the target object 708 may then reflect the transmissive signal 711 as the reflected signal 712 back towards the wireless device 704, and the wireless device 704 may then redirect the reflected signal 712 towards the network node 702 as the redirected reflected signal 713. The network node 702 may then perform sensing on the redirected reflected signal 713 to determine attributes of the target object 708. In some aspects, the network node 702 may transmit a sensing report to a sensing entity, such as an LMF.

FIG. 7B is a diagram 730 illustrating an example of the wireless device 704 configured to assist the network node 702 in performing bistatic sensing of the target object 708 with the UE 703. The UE 703 may be located opposite the network node 702 relative to the blocking object 706.

In response to the sensing signal transmitter (e.g., the network node 702) and the sensing signal receiver (e.g., the UE 703) being on two opposing sides of the wireless device 704, the network node 702 may be configured to act as the transmitter of a bistatic radar while the UE 703 (or another network node) may be configured to act as the receiver of the bistatic radar. The network node 702 may configure the wireless device 704 to use the entire meta-surface for a transmission direction, for example from the side with the network node 702 to the side with the UE 703 or vice-versa. In some aspects, the configuration may include the transmission direction. For example, in one aspect the network node 702 may transmit a configuration to the wireless device 704 to use the entire meta-surface for transmitting a signal from the side with the network node 702 to the side with the UE 703, or to use the entire meta-surface for transmitting a signal from the side with the UE 703 to the side with the network node 702, or to use a first section of the meta-surface for transmitting a first signal from the side with the network node 702 to the side with the UE 703 and a second section of the meta-surface for transmitting a second signal from the side with the UE 703 to the side with the network node 702. The network node 702 may indicate the first section and the second section in a plurality of ways, for example by designating percentages to each section (e.g., 50% for the first section and 50% for the second section, or 30% for the first section and 70% for the second section) or by designating coordinates to each section (e.g., (0,0), (20,20) for two opposing corners of the first section and (20,0), (40,20) for two opposing corners of the second section).

The network node 702 may configure the wireless device 704 to use the entire meta-surface of the wireless device 704 (i.e., all of its meta-elements) for a single transmission direction, irrespective of a capability report that may be transmitted to the network node 702 by the wireless device 704. In some aspects, the network node 702 may configure the wireless device 704 to redirect signals in a direction, for example from the side with the network node 702 towards the side with the target object 708. In such an aspect, the network node 702 may transmit a sensing signal 710 to the wireless device 704, the wireless device may redirect the sensing signal 710 as the transmissive signal 711 at the target object 708, and the target object 708 may then reflect the transmissive signal 711 as the reflected signal 744 towards the UE 703. In some aspects, the network node 702 may configure the wireless device 704 to designate at least a portion, or the entire, surface for a transmission direction (e.g., from the side with the network node 702 to the side with the UE 703 or from the side with the UE 703 to the side with the network node 702.). In response to receiving the transmission direction, the wireless device 704 may alter the transmissive coefficient value of one or more elements to realize the configured transmission direction. The UE 703 may perform sensing on the reflected signal 744 to determine attributes of the target object 708. In some aspects, the UE 703 may transmit a sensing report to the network node 702 or another sensing entity, such as an LMF.

FIG. 7C is a diagram 760 illustrating an example of the wireless device 764 configured to assist the network node 702 in performing monostatic or bistatic sensing of the target object 708 using a plurality of differently configured surfaces, a first section 765 and a second section 767. The network node 702 may perform monostatic sensing by measuring the redirected reflected signal 773 from the wireless device 764, or may perform bistatic sensing by configuring the UE 763 to measure the redirected reflected signal 774 from the wireless device 764.

The wireless device 764 may be configured to transmit a capability report message to the network node 702 indicating its capability of bidirectional transmission. The wireless device 764 may indicate for each meta-element configuration (e.g., electrical voltage), whether the transmissive coefficient values for two transmission directions are identical or different. In some aspects, the wireless device 764 may also report whether it may support simultaneous bidirectional transmission. Such a report may be used in aspects where simultaneous bidirectional transmission is not a standard capability.

In response to receiving the report, the network node 702 may transmit a message to the wireless device 764 to configure transmission directions and surface split based on a sensing type. If the sensing signal transmitter and the receiver are on the same side of the wireless device 764, the network node 702 may act as a monostatic radar, or the network node 702 and the UE 763 may act as a bistatic radar. If, for a certain configuration (e.g., an electrical voltage), the meta-element transmissive coefficient value is relevant to the incident angle, the network node 702 may configure the wireless device 764 to split the meta-surface into a first section 765 for a first transmission direction and a second section 767 for a second transmission direction. In such an aspect, the network node 702 may transmit a sensing signal 770 to the first section 765 of the surface of the wireless device 764, the wireless device 764 may redirect the sensing signal 770 as the transmissive signal 771 at the target object 708, the target object 708 may then reflect the transmissive signal 771 as the reflected signal 772 back towards the second section 767 of the surface of the wireless device 764, and the wireless device 764 may then redirect the reflected signal 772 towards the network node 702 as the redirected reflected signal 773 and/or towards the UE 763 as the redirected reflected signal 774. In some aspects, the wireless device 764 may be configured to redirect all of the reflected signal 772 towards the network node 702 as the redirected reflected signal 773, in other aspects, the wireless device may be configured to redirect all of the reflected signal 772 towards the UE 763 as the redirected reflected signal 774, and in still other aspects the wireless device may be configured to redirect a first portion of the reflected signal 772 towards the network node 702 as the redirected reflected signal 773 and a second portion of the reflected signal 772 towards the UE 763 as the redirected reflected signal 774.

The network node 702 may perform sensing on the redirected reflected signal 773 to determine attributes of the target object 708. In some aspects, the network node 702 may transmit a sensing report to a sensing entity, such as an LMF. The UE 763 may perform sensing on the redirected reflected signal 774 to determine attributes of the target object 708. In some aspects, the UE 763 may transmit a sensing report to the network node 702 or to a sensing entity, such as an LMF.

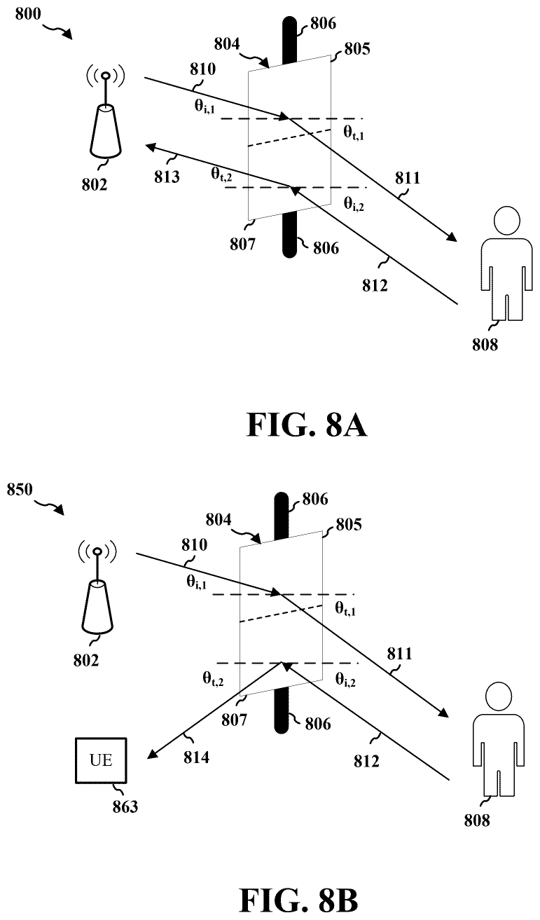

FIG. 8A is a diagram 800 illustrating another example of a wireless device 804 configured to assist a network node 802 in performing monostatic sensing of a target object 808 using a plurality of differently configured surfaces of the wireless device 804—namely a first section 805 of the wireless device 804 and a second section 807 of the wireless device 804. The wireless device 804 may provide a window between a blocking object 806 that does not allow wireless signals from the network node 802 to penetrate. In other words, the wireless device 804 may be a transmissive object that may be used for a radar (e.g., a network node or a UE) outside an enclosed space to sense an object within the enclosed space.

The network node 802 may configure the wireless device 804 via a configuration transmitted to the wireless device 804. The configuration may include an indication of an incident angle θ_{i,1} of the sensing signal 810 at the surface of the first section 805 or a distance between the network node 802 and the wireless device 804. The configuration may include an indication of a transmissive angle θ_{t,2} of the redirected reflected signal 813 at the surface of the second section 807 or a distance between the network node 802 and the wireless device 804. The wireless device 804 may use the incident angle θ_{i,1} or the distance between the network node 802 and the wireless device 804 to configure the first section 805 of the wireless device 804 to redirect the sensing signal 810 to a direction, such as the transmissive angle θ_{t,1} of the transmissive sensing signal 811, which may be used to sense the target object 808, or an area about the target object 808. The wireless device 804 may use the transmissive angle θ_{t,2} or the distance between the network node 802 and the wireless device 804 to redirect the reflected signal 812 as the redirected reflected signal 813 back to the network node 802. Since the network node 802 performs monostatic sensing, the incident angle θ_{i,1} may equal the transmissive angle θ_{t,2}. In some aspects, the network node 802 may configure the wireless device 804 using the distance between the network node 802 and the wireless device 804 when the network node 802 is in a near field of the wireless device 804.

In some aspects, the configuration may include an indication of the wireless device 804 to perform beam sweeping using the sensing signal 810 to sweep the transmissive sensing signal 811 across an area. In other words, the wireless device 804 may change a transmissive coefficient of elements of the surface of the first section 805 of the wireless device 804 to change the transmissive angle θ_{t,1} of the transmissive sensing signal 811 to cover an area. The wireless device 804 may also change a transmissive coefficient of elements of the surface of the second section 807 of the wireless device 804 to account for the change in the incident angle θ_{t,2} of the reflected signal 812 to such that the transmissive angle θ_{t,2} remains constantly focused back at the network node 802 as the wireless device 804 performs the beam sweeping.

The network node 802 may transmit a sensing signal 810 to the first section 805 of the wireless device 804 at an incident angle θ_{i,1}. The wireless device 804 may redirect the sensing signal 810 as the transmissive sensing signal 811 to the target object 808 at the transmissive angle θ_{t,1}. The target object 808 may reflect the transmissive sensing signal 811 to the second section 807 of the wireless device 804 at the incident angle θ_{i,2} as the reflected signal 812. The wireless device 804 may redirect the reflected signal 812 back towards the network node 802 at the transmissive angle θ_{t,2} as the redirected reflected signal 813. The network node 802 may then perform sensing on the redirected reflected signal 813 to determine attributes of the target object 808. In some aspects, the network node 802 may transmit a sensing report to a sensing entity, such as an LMF.

FIG. 8B is a diagram 850 illustrating another example of a wireless device 804 configured to assist a network node 802 in performing bistatic sensing of a target object 808 using a plurality of differently configured surfaces—namely a first section 805 of the wireless device 804 and a second section 807 of the wireless device 804, with a UE 863 acting as a sensing receiver.

The network node 802 may configure the wireless device 804 via a configuration transmitted to the wireless device 804. The configuration may include an indication of an incident angle θ_{i,1} of the sensing signal 810 at the surface of the first section 805 or a distance between the network node 802 and the wireless device 804. The configuration may include an indication of a transmissive angle θ_{t,2} of the redirected reflected signal 813 at the surface of the second section 807 or a distance between the UE 863 and the wireless device 804. The wireless device 804 may use the incident angle θ_{t,1} or the distance between the network node 802 and the wireless device 804 to configure the first section 805 of the wireless device 804 to redirect the sensing signal 810 to a direction, such as the transmissive angle θ_{t,1} of the transmissive sensing signal 811, which may be used to sense the target object 808, or an area about the target object 808. The wireless device 804 may use the transmissive angle θ_{t,2} or the distance between the UE 863 and the wireless device 804 to redirect the reflected signal 812 as the redirected reflected signal 814 to the UE 863. Since the network node 802 performs bistatic sensing, the incident angle θ_{t,1} may not be equal the transmissive angle θ_{t,2}. In some aspects, the network node 802 may configure the wireless device 804 using the distance between the network node 802 and the wireless device 804 and the distance between the UE 863 and the wireless device 804 when the network node 802 is in a near field of the wireless device 804 and the UE 863 is in a near field of the wireless device 804.

In some aspects, the configuration may include an indication of the wireless device 804 to perform beam sweeping using the sensing signal 810 to sweep the transmissive sensing signal 811 across an area. In other words, the wireless device 804 may change a transmissive coefficient of elements of the surface of the first section 805 of the wireless device 804 to change the transmissive angle θ_{t,2} of the transmissive sensing signal 811 to cover an area. The wireless device 804 may also change a transmissive coefficient of elements of the surface of the second section 807 of the wireless device 804 to account for the change in the incident angle θ_{i,2} of the reflected signal 812 to such that the transmissive angle θ_{i,2} remains constantly focused back at the UE 863 as the wireless device 804 performs the beam sweeping.

The network node 802 may transmit a sensing signal 810 to the first section 805 of the wireless device 804 at an incident angle θ_{i,1}. The wireless device 804 may redirect the sensing signal 810 as the transmissive sensing signal 811 to the target object 808 at the transmissive angle θ_{t,1}. The target object 808 may reflect the transmissive sensing signal 811 to the second section 807 of the wireless device 804 at the incident angle θ_{i,2} as the reflected signal 812. The wireless device 804 may redirect the reflected signal 812 back towards the UE 863 at the transmissive angle θ_{t,2} as the redirected reflected signal 814. The UE 863 may then perform sensing on the redirected reflected signal 814 to determine attributes of the target object 808. In some aspects, the UE 863 may transmit a sensing report to the network node 802 or a sensing entity, such as an LMF.

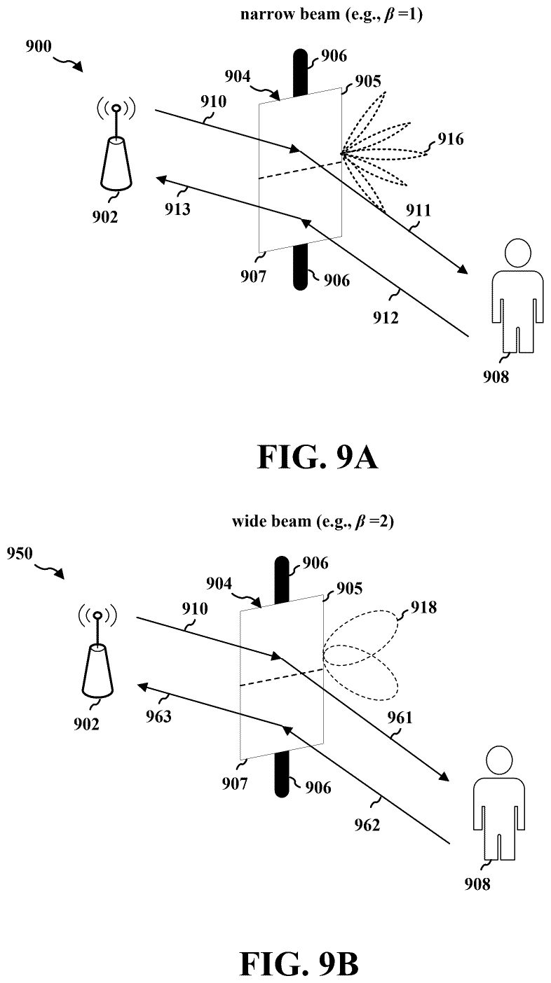

FIG. 9A is a diagram 900 illustrating another example of a wireless device 904 configured to assist a network node 902 in performing monostatic sensing of a target object 908. The wireless device 904 may be configured to generate a transmissive beamforming gain equal to

$$\frac{{g}_{max}}{β} ,$$

where gₘₐₓ may be the maximum transmissive beamforming gain with the narrowest beam, and β may be a beamforming gain factor. In some aspects, the possible values of β may be [1, 2, 3, 4, . . . ] or [1, 2, 4, 8, . . . ]. In other words, the values of β may be consecutive integers, or may be doubled for each subsequent value of β.

The wireless device 904 may provide a window between a blocking object 906 that does not allow wireless signals from the network node 902 to penetrate. In other words, the wireless device 904 may be a transmissive object that may be used for a radar (e.g., a network node or a UE) outside an enclosed space to sense an object within the enclosed space.

The network node 902 may transmit a sensing signal 910 to the first section 905 of the wireless device 904. The wireless device 904 may redirect the sensing signal 910 as the transmissive sensing signal 911 to the target object 908. The wireless device 904 may redirect the sensing signal 910 by applying an initial beamforming factor of β=1 to form a narrow beam 916 towards the target object 908. The target object 908 may reflect the transmissive sensing signal 911 to the second section 907 of the wireless device 904 as the reflected signal 912. The wireless device 904 may redirect the reflected signal 912 back towards the network node 902 as the redirected reflected signal 913. The network node 902 may then perform sensing on the redirected reflected signal 913 to determine attributes of the target object 908. In some aspects, the network node 902 may transmit a sensing report to a sensing entity, such as an LMF.

Based on the received sensing signal strength of the redirected reflected signal 913, the network node 902 may dynamically reconfigure the beamforming gain factor β so that the new transmissive beamforming gain is increased or decreased.

FIG. 9B is a diagram 950 illustrating an example of the wireless device 904 configured to use a new beamforming factor of β=2 to form a wide beam 918. The network node 902 may transmit a sensing signal 910 to the first section 905 of the wireless device 904. The wireless device 904 may redirect the sensing signal 910 as the transmissive sensing signal 961 to the target object 908. The wireless device 904 may redirect the sensing signal 910 by applying an updated beamforming factor of β=2 to form a wide beam 918 towards the target object 908. The target object 908 may reflect the transmissive sensing signal 961 to the second section 907 of the wireless device 904 as the reflected signal 962. The wireless device 904 may redirect the reflected signal 962 back towards the network node 902 as the redirected reflected signal 963. The network node 902 may then perform sensing on the redirected reflected signal 963 to determine attributes of the target object 908. In some aspects, the network node 902 may transmit a sensing report to a sensing entity, such as an LMF.

The network node 902 may transmit a configuration of the sensing signal 910 to the wireless device 904 to apply the beamforming gain factor β to the sensing signal 910. The network node 902 may dynamically reconfigure the beamforming gain factor β to increase or decrease the beamforming applied by the wireless device 904. In one aspect, the network node 902 may initially transmit a beamforming gain factor β to the wireless device 804. Later, the network node 902 may indicate a new beamforming gain factor as an absolute value. In other words, the network node 902 may initially transmit a beamforming gain factor β₁, such that the transmissive beamforming gain is

$${g}_{1} = \frac{{g}_{max}}{{β}_{1}} ,$$

and then may transmit a beamformifng gain factor β₂, such that the transmissive beamforming gain is

$${g}_{2} = \frac{{g}_{max}}{{β}_{2}} .$$

In another aspect, the network node 902 may initially transmit a beamforming gain factor β to the wireless device 804. Later, the network node 902 may indicate a new beamforming gain factor as a relative change value from the previous beamforming gain factor. In other words, the network node 902 may initially transmit a beamforming gain factor β₁, such that the transmissive beamforming gain is

$${g}_{1} = \frac{{g}_{max}}{{β}_{1}} ,$$

and then may transmit a relative change value in the beamforming gain factor Δₚ, such that the transmissive beamforming gain is

$${g}_{2} = \frac{{g}_{max}}{{β}_{1} + {Δ}_{β}} .$$

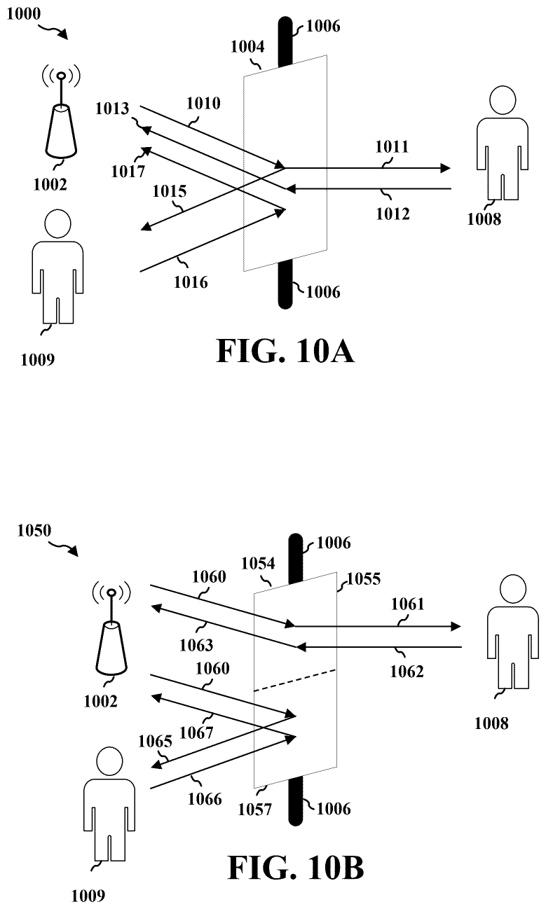

FIG. 10A is a diagram 1000 illustrating an example of a wireless device 1004 configured to assist a network node 1002 in performing monostatic sensing of a target object 1008 opposite the network node 1002 and a target object 1009 on the same side as the network node 1002. In other words, the network node 1002 may sense areas located on both sides of the wireless device 1004 (e.g., an indoor area and an outdoor area, or two neighbor rooms separated by a wall). The wireless device 1004 may be configured to use both transmissive and reflective properties of its meta-elements to achieve this. The wireless device 1004 may provide a window between a blocking object 1006 that does not allow wireless signals from the network node 1002 to penetrate. In other words, the wireless device 1004 may be a transmissive object that may be used for a radar (e.g., a network node or a UE) outside an enclosed space to sense an object within the enclosed space.

The wireless device 1004 may transmit a capability report message to the network node 1002. The capability report message may indicate whether and how to support simultaneous transmissive and reflective properties of its elements. The capability report message may indicate a capability type of a set of elements of the wireless device 1004. A first capability type may be associated with a set of elements that are configured to support either transmissive signals or reflective signals. A second capability type may be associated with a set of elements that are configured to support both transmissive signals and reflective signals, where the power may have a fixed split between transmission and reflection (e.g., half of the signal is transmitted, and half of the signal is reflected). A third capability type may be associated with a set of elements that are configured to support both transmissive signals and reflective signals, where the power split between transmission and reflection may be configurable. In some aspects, the wireless device 1004 may have a plurality of selectable splits, which the wireless device 1004 may indicate to the network node 1002 (e.g., a first power split ratio of ⅓ transmissive: ⅔ reflective, a second power split ratio of ½ transmissive: ½ reflective, and a third power split ratio of ⅔ transmissive: ⅓ reflective). The network node 1002 may configure the wireless device 1004 in response to the capability report message. For example, if the capability report message indicates that a set of elements may be configured to be either transmissive or reflective, the network node 1002 may configure a first portion of the surface to be transmissive and a second portion of the surface to be reflective, for example half of the surface for transmissive signals and half of the surface for reflective signals, or 40% of the surface for transmissive signals and 60% of the surface for reflective signals. In some aspects, the network node 1002 may configure a time occasion pattern, such that in one time occasion the wireless device 1004 is configured for a transmissive signal, and in another time occasion the wireless device 1004 is configured for a reflective signal. The network node 1002 may indicate a time length for the transmissive signal and a time length for the reflective signal, and the wireless device 1004 may alternate each configuration accordingly.

If the capability report message indicates that a set of elements may be configured to be both transmissive or reflective, the network node 1002 may configure the surface of the wireless device 1004 to be both transmissive and reflective. The network node 1002 may transmit an indication of the incident angle for the sensing signal 1010, the transmissive angle for the redirected reflected signal 1013, and the reflective angle for the reflected signal 1017 to the wireless device 1004, and may indicate for the wireless device 1004 to sweep beams across an area on one side of the wireless device 1004 (for the transmissive signal 1011) and sweep beams across an area of the other side of the wireless device 1004 (for the reflective signal 1015) while redirecting the redirected reflected signal 1013 and the reflected signal 1017 back to the network node 1002. Based on the indicated angles, the wireless device 1004 may configure its meta-elements to generate both the transmissive and reflective coefficients such that both the transmissive and reflective beams aim at the respective target directions. In other words, the transmissive signal 1011 aims at the target object 1008, or an area about the target object 1008, and the reflective signal 1015 aims at the target object 1009, or an area about the target object 1009. In some aspects, the coefficient value may be irrelevant to the incident angle (e.g., at a certain electrical voltage of the wireless device 1004). The wireless device 1004 may report this capability to the network node 1002. In response, the network node 1002 may configure the wireless device 1004 to use its entire surface for both transmissive and reflective sensing signals.

If the capability report message indicates that a set of elements may be configured to be both transmissive or reflective with a configurable power split, the network node 1002 may indicate the power split ratio to use. In some aspects, the network node 1002 may configure the power split based on a distance to a target object or a size of a target object. For example, if the distance between the wireless device 1004 and the target object 1008 is greater than the distance between the wireless device 1004 and the target object 1009, the network node 1002 may configure more power to the transmissive signal (e.g., select a power split ratio such that the transmissive signal 1011 is stronger than the reflective signal 1015). In another example, if the size of the target object 1009 is smaller than the size of the target object 1008, the network node 1002 may configure more power to the reflective signal (e.g., select a power split ratio such that the reflective signal 1015 is stronger than the transmissive signal 1011).

The network node 1002 may transmit a sensing signal 1010 to the wireless device 1004, the wireless device may redirect a portion of the sensing signal 1010 as the transmissive signal 1011 at the target object 1008, the target object 1008 may then reflect the transmissive signal 1011 as the reflected signal 1012 back towards the wireless device 1004, and the wireless device 1004 may then redirect the reflected signal 1012 towards the network node 1002 as the redirected reflected signal 1013. The network node 1002 may then perform sensing on the redirected reflected signal 1013 to determine attributes of the target object 1008. In some aspects, the network node 1002 may transmit a sensing report to a sensing entity, such as an LMF.

The wireless device may also reflect a portion of the sensing signal 1010 as the reflective signal 1015 at the target object 1009, the target object 1009 may then reflect the reflective signal 1015 as the reflected signal 1016 back towards the wireless device 1004, and the wireless device 1004 may then reflect the reflected signal 1016 towards the network node 1002 as the reflected signal 1017. The network node 1002 may then perform sensing on the reflected signal 1017 to determine attributes of the target object 1009. In some aspects, the network node 1002 may transmit a sensing report to a sensing entity, such as an LMF.

FIG. 10B is a diagram 1050 illustrating an example of a wireless device 1054 configured to assist a network node 1002 in performing monostatic sensing of a target object 1008 opposite the network node 1002 and a target object 1009 on the same side as the network node 1002 using a first section 1055 of the surface of the wireless device 1054 and a second section 1057 of the surface of the wireless device 1054. The wireless device 1054 may be configured to use transmissive properties of the first section 1055 of the wireless device 1054 and reflective properties of the second section 1057 of the wireless device 1054 to achieve this.

The network node 1002 may transmit a sensing signal 1060 to the first section 1055 of the wireless device 1004, the first section 1055 of the wireless device 1054 may redirect a portion of the sensing signal 1060 as the transmissive signal 1061 at the target object 1008, the target object 1008 may then reflect the transmissive signal 1061 as the reflected signal 1062 back towards the first section 1055 of the wireless device 1054, and the first section 1055 of the wireless device 1054 may then redirect the reflected signal 1062 towards the network node 1002 as the redirected reflected signal 1063. The network node 1002 may then perform sensing on the redirected reflected signal 1063 to determine attributes of the target object 1008. In some aspects, the network node 1002 may transmit a sensing report to a sensing entity, such as an LMF.

The second section 1057 of the wireless device may also reflect a portion of the sensing signal 1060 as the reflective signal 1065 at the target object 1009, the target object 1009 may then reflect the reflective signal 1065 as the reflected signal 1066 back towards the second section 1057 of the wireless device 1004, and the second section 1057 of the wireless device 1004 may then reflect the reflected signal 1066 towards the network node 1002 as the reflected signal 1067. The network node 1002 may then perform sensing on the reflected signal 1067 to determine attributes of the target object 1009. In some aspects, the network node 1002 may transmit a sensing report to a sensing entity, such as an LMF.

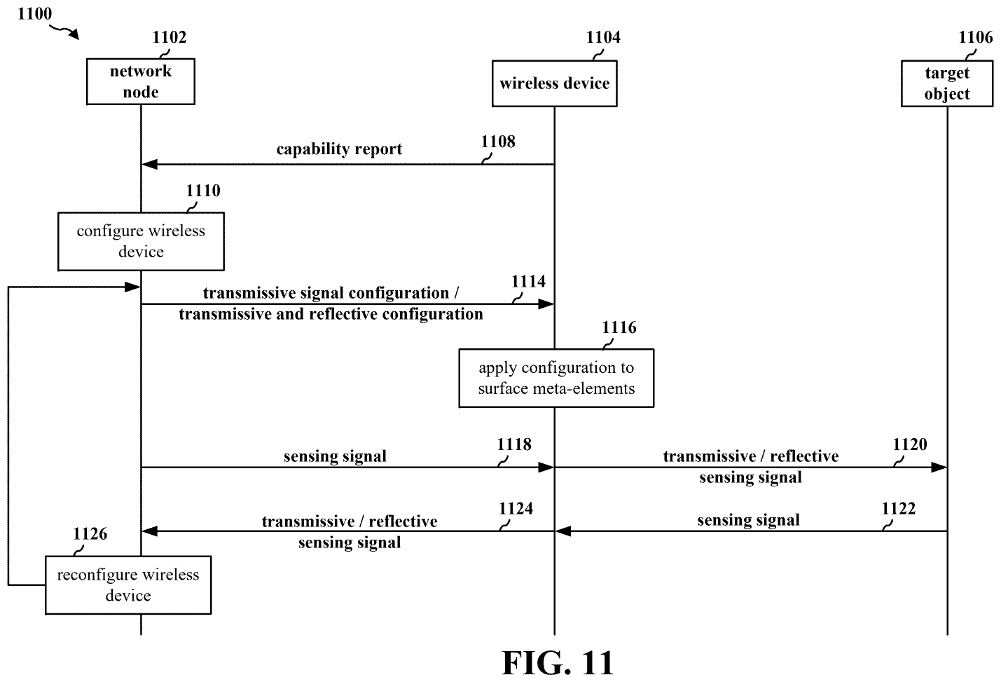

FIG. 11 is a connection flow diagram 1100 illustrating an example of communications between a network node 1102 and a wireless device 1104 configured to assist the network node 1102 in performing sensing on a target object 1106. The wireless device 1104 may transmit a capability report 1108 to the network node 1102. The capability report 1108 may indicate whether and how to support simultaneous transmission (penetration) and reflection. At 1110, the network node 1102 may configure the wireless device 1104. The network node 1102 may transmit a transmissive signal configuration or a transmissive and reflective configuration 1114 to the wireless device 1104. At 1116, the wireless device 1104 may apply the received configuration to meta-elements at its surface. The network node 1102 may transmit a sensing signal 1118 to the wireless device 1104. The wireless device 1104 may transmit and/or reflect portions of the sensing signal 1118 as the transmissive/reflective sensing signal 1120 at the target object 1106. The target object 1106 may reflect the received signal as the sensing signal 1122 at the wireless device 1104. The wireless device 1104 may transmit and/or reflect portions of the sensing signal 1122 at the network node 1102 as the transmissive/reflective sensing signal 1124. At 1126, the network node 1102 may reconfigure the wireless device 1104 based on measurements of the transmissive/reflective sensing signal 1124.

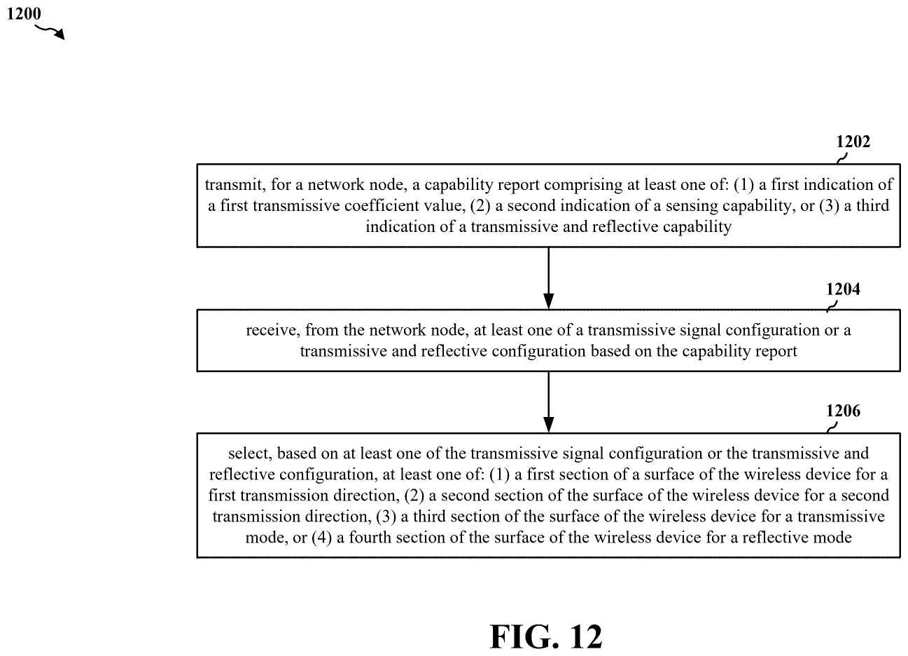

FIG. 12 is a flowchart 1200 of a method of wireless communication. The method may be performed by a wireless device (e.g., the wireless device 106, the wireless device 506, the wireless device 608, the wireless device 658, the wireless device 704, the wireless device 804, the wireless device 904, the wireless device 1004, the wireless device 1104). At 1202, the wireless device may transmit, for a network node, a capability report including at least one of: (1) a first indication of a first transmissive coefficient value, (2) a second indication of a sensing capability, or (3) a third indication of a transmissive and reflective capability. For example, 1202 may be performed by the wireless device 1104 in FIG. 11, which may transmit, for the network node 1002, a capability report 1108 including at least one of: (1) a first indication of a first transmissive coefficient value for the surface of the wireless device 1004, (2) an indication of its sensing capability, or (3) an indication of a transmissive and reflective capability. Moreover, 1202 may be performed by the component 198 in FIG. 1 or 5.

At 1204, the wireless device may receive, from the network node, at least one of a transmissive signal configuration or a transmissive and reflective configuration based on the capability report. For example, 1204 may be performed by the wireless device 1104 in FIG. 11, which may receive, from the network node 1102, at least one of a transmissive signal configuration or a transmissive and reflective configuration 1114 based on the capability report 1108. Moreover, 1204 may be performed by the component 198 in FIG. 1 or 5.

At 1206, the wireless device may select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. For example, 1206 may be performed by the wireless device 1104 in FIG. 11, which may select, based on at least one of the transmissive signal configuration or the transmissive and reflective configuration 1114, at least one of: (1) a first section of a surface of the wireless device 1004 for a first transmission direction, (2) a second section of the surface of the wireless device 1004 for a second transmission direction, (3) a third section of the surface of the wireless device 1004 for a transmissive mode, or (4) a fourth section of the surface of the wireless device 1004 for a reflective mode. Moreover, 1206 may be performed by the component 198 in FIG. 1 or 5.

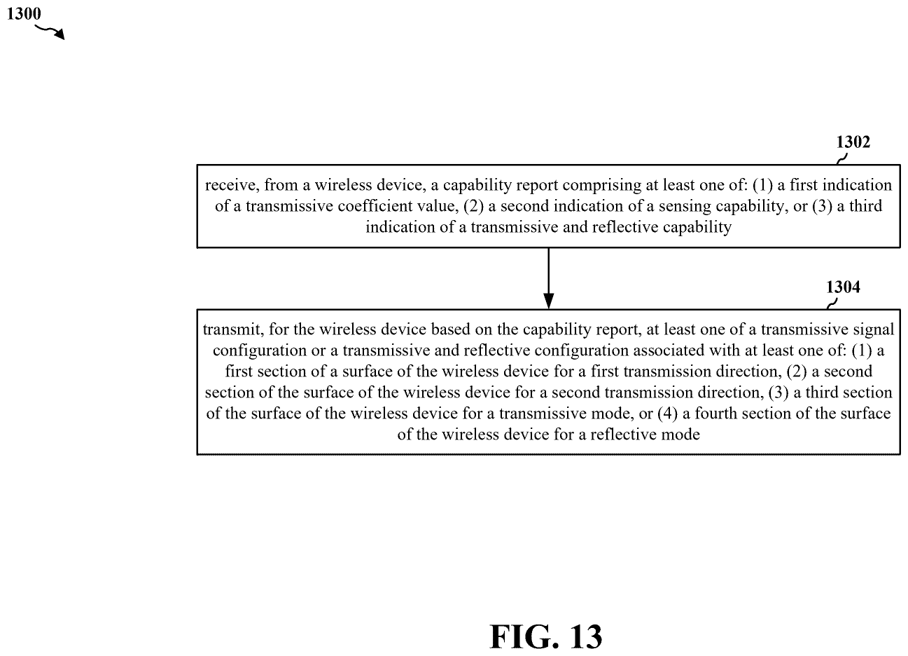

FIG. 13 is a flowchart 1300 of a method of wireless communication. The method may be performed by a network node (e.g., the base station 102, the base station 310; the wireless node 402, the wireless node 404, the wireless node 406, the wireless node 408; the network node 502, the network node 602, the network node 702, the network node 802, the network node 902, the network node 1002, the network node 1102; the network entity 1402, the network entity 1560). At 1302, the network node may receive, from a wireless device, a capability report including at least one of: (1) a first indication of a transmissive coefficient value, (2) a second indication of a sensing capability, or (3) a third indication of a transmissive and reflective capability. For example, 1302 may be performed by the network node 1102 in FIG. 11, which may receive, from the wireless device 1104, a capability report 1108 including at least one of: (1) a first indication of a transmissive coefficient value, (2) a second indication of a sensing capability, or (3) a third indication of a transmissive and reflective capability. Moreover, 1302 may be performed by the component 199 in FIG. 1, 3, 14, or 15.

At 1304, the network node may transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. For example, 1304 may be performed by the network node 1102 in FIG. 11, which may transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. Moreover, 1304 may be performed by the component 199 in FIG. 1, 3, 14, or 15.

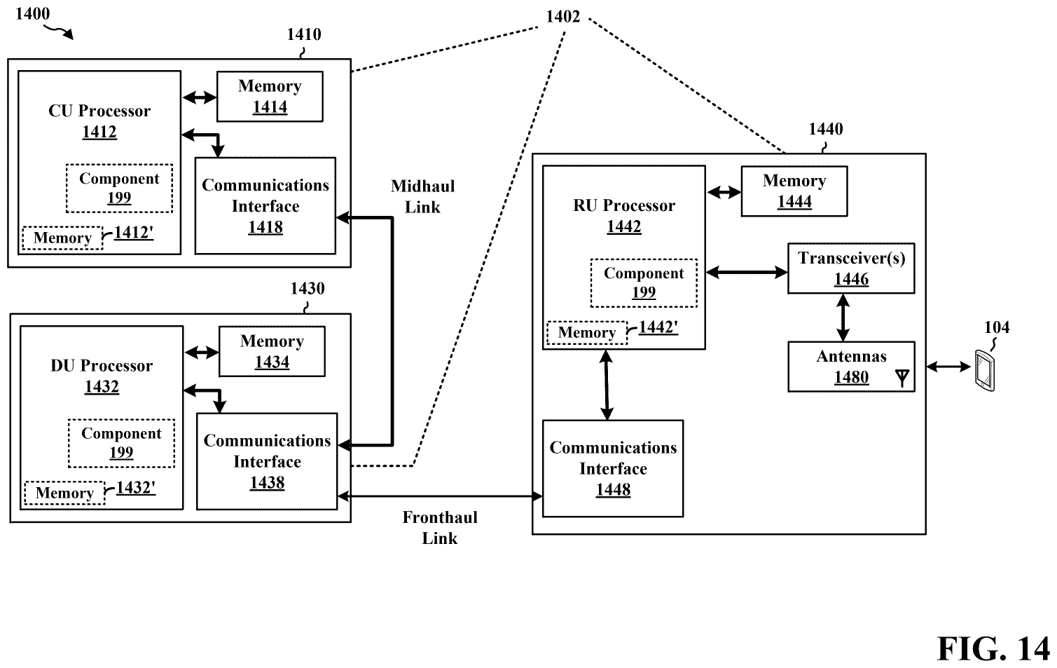

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440.

The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a wireless device, a capability report including at least one of: (1) a first indication of a transmissive coefficient value, (2) a second indication of a sensing capability, or (3) a third indication of a transmissive and reflective capability. The component 199 may be configured to transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for receiving, from a wireless device, a capability report including at least one of: (1) a first indication of a transmissive coefficient value, (2) a second indication of a sensing capability, or (3) a third indication of a transmissive and reflective capability. The network entity 1402 may include means for transmitting, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The capability report may include a fourth indication of a bidirectional transmission capability. The network entity 1402 may include means for configuring at least one of the transmissive signal configuration or the transmissive and reflective configuration to overlap the first section for the first transmission direction and the second section for the second transmission direction based on the fourth indication of the bidirectional transmission capability indicating that the wireless device is capable of simultaneous bidirectional transmission. The network entity 1402 may include means for configuring at least one of the transmissive signal configuration or the transmissive and reflective configuration to split the surface of the wireless device into the first section for the first transmission direction and the second section for the second transmission direction based on the fourth indication of the bidirectional transmission capability indicating that the wireless device is not capable of the simultaneous bidirectional transmission. The capability report may include a fourth indication of whether the transmissive coefficient value is relevant to an incident angle of a transmitted signal. The network entity 1402 may include means for configuring at least one of the transmissive signal configuration or the transmissive and reflective configuration to split the surface of the wireless device into the first section for the first transmission direction and the second section for the second transmission direction based on the fourth indication indicating that the transmissive coefficient value is relevant to the incident angle of the transmitted signal. The network entity 1402 may include means for configuring at least one of the transmissive signal configuration or the transmissive and reflective configuration to overlap the first section for the first transmission direction and the second section for the second transmission direction based on the fourth indication indicating that the transmissive coefficient value is not relevant to the incident angle of the transmitted signal. At least one of the transmissive signal configuration or the transmissive and reflective configuration may include a fourth indication of an entire surface area of the surface of the wireless device for the first transmission direction. At least one of the transmissive signal configuration or the transmissive and reflective configuration may include a fifth indication of the first transmission direction. At least one of the transmissive signal configuration or the transmissive and reflective configuration may include a fourth indication of at least one of an incident angle or an incident distance for the first section of the surface of the wireless device for the first transmission direction. At least one of the transmissive signal configuration or the transmissive and reflective configuration may include a fifth indication of at least one of a transmissive angle or a transmissive distance for the second section of the surface of the wireless device. At least one of the transmissive signal configuration or the transmissive and reflective configuration may further include a sixth indication of at least one of a minimum transmissive angle or a maximum transmissive angle for beam sweeping a sensing signal. At least one of the transmissive signal configuration or the transmissive and reflective configuration may further include a seventh indication of at least one of a minimum incident angle or a maximum incident angle for beam sweeping the sensing signal. At least one of the transmissive signal configuration or the transmissive and reflective configuration may include a first beamforming gain factor associated with a set of meta-elements of the surface of the wireless device. The network entity 1402 may include means for transmitting a sensing signal to the wireless device. The network entity 1402 may include means for transmitting a sensing signal to the wireless device. The network entity 1402 may include means for transmitting at least one of a second transmissive signal configuration or a second transmissive and reflective configuration including a second beamforming gain factor based on the received reflected signal. At least one of the second transmissive signal configuration or the second transmissive and reflective configuration may include at least one of an absolute gain value or a relative gain value relative to the first beamforming gain factor. The third indication of the transmissive and reflective capability may indicate that a power split between transmission and reflection associated with a set of meta-elements of the surface of the wireless device is configurable. The network entity 1402 may include means for configuring at least one of the transmissive signal configuration or the transmissive and reflective configuration to indicate a power split ratio between the transmission and the reflection. The third section and the fourth section may include an overlapping section of the surface of the wireless device. The network entity 1402 may include means for configuring at least one of the transmissive signal configuration or the transmissive and reflective configuration to indicate a first set of time periods for the overlapping section of the surface of the wireless device and a second set of time periods for the overlapping section of the surface of the wireless device. The first set of time periods and the second set of time periods may be non-overlapping. The network entity 1402 may include means for configuring at least one of the transmissive signal configuration or the transmissive and reflective configuration to indicate at least one of a transmissive coefficient for the third section of the surface or a reflective coefficient for the fourth section of the surface based. The wireless device may include a RIS. The first section and the second section may overlap. The means may be the component 199 of the network entity 1402 configured to perform the functions recited by the means. As described supra, the network entity 1402 may include the Tx processor 316, the Rx processor 370, and the controller/processor 375. As such, in one configuration, the means may be the Tx processor 316, the Rx processor 370, and/or the controller/processor 375 configured to perform the functions recited by the means.

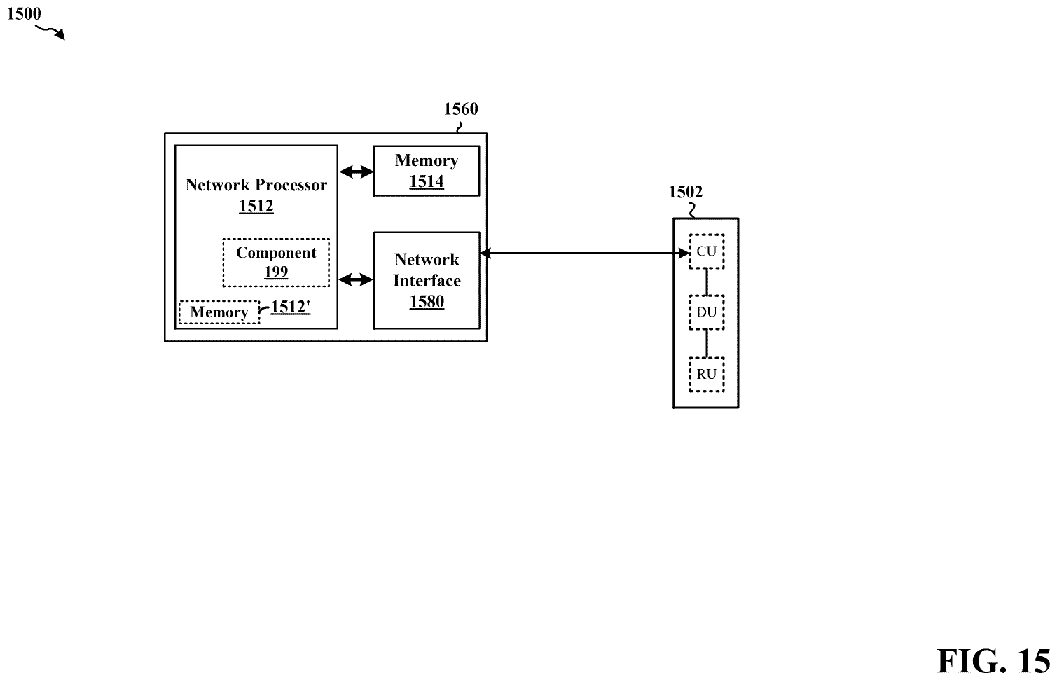

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a wireless device, a capability report including at least one of: (1) a first indication of a transmissive coefficient value, (2) a second indication of a sensing capability, or (3) a third indication of a transmissive and reflective capability. The component 199 may be configured to transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 may include means for receiving, from a wireless device, a capability report including at least one of: (1) a first indication of a transmissive coefficient value, (2) a second indication of a sensing capability, or (3) a third indication of a transmissive and reflective capability. The network entity 1560 may include means for transmitting, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode. The capability report may include a fourth indication of a bidirectional transmission capability. The network entity 1560 may include means for configuring at least one of the transmissive signal configuration or the transmissive and reflective configuration to overlap the first section for the first transmission direction and the second section for the second transmission direction based on the fourth indication of the bidirectional transmission capability indicating that the wireless device is capable of simultaneous bidirectional transmission. The network entity 1560 may include means for configuring at least one of the transmissive signal configuration or the transmissive and reflective configuration to split the surface of the wireless device into the first section for the first transmission direction and the second section for the second transmission direction based on the fourth indication of the bidirectional transmission capability indicating that the wireless device is not capable of the simultaneous bidirectional transmission. The capability report may include a fourth indication of whether the transmissive coefficient value is relevant to an incident angle of a transmitted signal. The network entity 1560 may include means for configuring at least one of the transmissive signal configuration or the transmissive and reflective configuration to split the surface of the wireless device into the first section for the first transmission direction and the second section for the second transmission direction based on the fourth indication indicating that the transmissive coefficient value is relevant to the incident angle of the transmitted signal. The network entity 1560 may include means for configuring at least one of the transmissive signal configuration or the transmissive and reflective configuration to overlap the first section for the first transmission direction and the second section for the second transmission direction based on the fourth indication indicating that the transmissive coefficient value is not relevant to the incident angle of the transmitted signal. At least one of the transmissive signal configuration or the transmissive and reflective configuration may include a fourth indication of an entire surface area of the surface of the wireless device for the first transmission direction. At least one of the transmissive signal configuration or the transmissive and reflective configuration may include a fifth indication of the first transmission direction. At least one of the transmissive signal configuration or the transmissive and reflective configuration may include a fourth indication of at least one of an incident angle or an incident distance for the first section of the surface of the wireless device for the first transmission direction. At least one of the transmissive signal configuration or the transmissive and reflective configuration may include a fifth indication of at least one of a transmissive angle or a transmissive distance for the second section of the surface of the wireless device. At least one of the transmissive signal configuration or the transmissive and reflective configuration may further include a sixth indication of at least one of a minimum transmissive angle or a maximum transmissive angle for beam sweeping a sensing signal. At least one of the transmissive signal configuration or the transmissive and reflective configuration may further include a seventh indication of at least one of a minimum incident angle or a maximum incident angle for beam sweeping the sensing signal. At least one of the transmissive signal configuration or the transmissive and reflective configuration may include a first beamforming gain factor associated with a set of meta-elements of the surface of the wireless device. The network entity 1560 may include means for transmitting a sensing signal to the wireless device. The network entity 1560 may include means for transmitting a sensing signal to the wireless device. The network entity 1560 may include means for transmitting at least one of a second transmissive signal configuration or a second transmissive and reflective configuration including a second beamforming gain factor based on the received reflected signal. At least one of the second transmissive signal configuration or the second transmissive and reflective configuration may include at least one of an absolute gain value or a relative gain value relative to the first beamforming gain factor. The third indication of the transmissive and reflective capability may indicate that a power split between transmission and reflection associated with a set of meta-elements of the surface of the wireless device is configurable. The network entity 1560 may include means for configuring at least one of the transmissive signal configuration or the transmissive and reflective configuration to indicate a power split ratio between the transmission and the reflection. The third section and the fourth section may include an overlapping section of the surface of the wireless device. The network entity 1560 may include means for configuring at least one of the transmissive signal configuration or the transmissive and reflective configuration to indicate a first set of time periods for the overlapping section of the surface of the wireless device and a second set of time periods for the overlapping section of the surface of the wireless device. The first set of time periods and the second set of time periods may be non-overlapping. The network entity 1560 may include means for configuring at least one of the transmissive signal configuration or the transmissive and reflective configuration to indicate at least one of a transmissive coefficient for the third section of the surface or a reflective coefficient for the fourth section of the surface based. The wireless device may include a RIS. The first section and the second section may overlap. The means may be the component 199 of the network entity 1560 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include transmitting, for a network node, a capability report including at least one of: (1) a first indication of a first transmissive coefficient value, (2) a second indication of a sensing capability, or (3) a third indication of a transmissive and reflective capability. The method may include receiving, from the network node, at least one of a transmissive signal configuration or a transmissive and reflective configuration based on the capability report. The method may include selecting, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

Aspect 2 is the method of aspect 1, where the capability report may include a fourth indication of whether the first transmissive coefficient value is associated with a monodirectional transmission or a bidirectional transmission.

Aspect 3 is the method of either of aspects 1 or 2, where the capability report may include a fourth indication of a bidirectional transmission capability.

Aspect 4 is the method of any of aspects 1 to 3, where the first transmissive coefficient value may be associated with the first transmission direction. The capability report may further include a fourth indication of a second transmissive coefficient value associated with the second transmission direction. The first transmissive coefficient value may be different from the second transmissive coefficient value. At least one of the transmissive signal configuration or the transmissive and reflective configuration may include a fifth indication of the first section of the surface of the wireless device for the first transmission direction and a sixth indication of the second section of the surface of the wireless device for the second transmission direction. Selecting the first section of the surface of the wireless device for the first transmission direction and the second section of the surface of the wireless device for the second transmission direction may be based on the fifth indication and the sixth indication of at least one of the transmissive signal configuration or the transmissive and reflective configuration.

Aspect 5 is the method of any of aspects 1 to 4, where the first transmissive coefficient value may be associated with the first transmission direction and the second transmission direction. At least one of the transmissive signal configuration or the transmissive and reflective configuration may include a fourth indication of an entire surface area of the surface of the wireless device for the first transmission direction and the second transmission direction. The method may include selecting the entire surface area of the surface of the wireless device as the first section of the surface of the wireless device for the first transmission direction and as the second section of the surface of the wireless device for the second transmission direction based on the fourth indication of at least one of the transmissive signal configuration or the transmissive and reflective configuration.

Aspect 6 is the method of any of aspects 1 to 5, where at least one of the transmissive signal configuration or the transmissive and reflective configuration may include a fourth indication of an entire surface area of the surface of the wireless device for the first transmission direction. The method may include selecting the entire surface area of the surface of the wireless device as the first section of the surface of the wireless device for the first transmission direction based on the fourth indication of at least one of the transmissive signal configuration or the transmissive and reflective configuration.

Aspect 7 is the method of aspect 6, where at least one of the transmissive signal configuration or the transmissive and reflective configuration may further include a fifth indication of the first transmission direction. Selecting the first section of the surface of the wireless device for the first transmission direction may be based on the fifth indication of at least one of the transmissive signal configuration or the transmissive and reflective configuration.

Aspect 8 is the method of any of aspects 1 to 7, where at least one of the transmissive signal configuration or the transmissive and reflective configuration may include a fourth indication of at least one of an incident angle or an incident distance for the first section of the surface of the wireless device for the first transmission direction. At least one of the transmissive signal configuration or the transmissive and reflective configuration may include a fifth indication of at least one of a transmissive angle or a transmissive distance for the second section of the surface of the wireless device. The method may include configuring a first transmissive coefficient of a first set of meta-elements of the first section of the surface of the wireless device based on the fourth indication of at least one of the incident angle or the incident distance. The method may include configuring a second transmissive coefficient of a second set of meta-elements of the second section of the surface of the wireless device based on the fifth indication of at least one of the transmissive angle or the transmissive distance.

Aspect 9 is the method of aspect 8, where the incident angle may be equal to the transmissive angle.

Aspect 10 is the method of either of aspects 8 or 9, where at least one of the transmissive signal configuration or the transmissive and reflective configuration may further include a sixth indication of at least one of a minimum transmissive angle or a maximum transmissive angle and a seventh indication of at least one of a minimum incident angle or a maximum incident angle. The method may include configuring the first transmissive coefficient of the first set of meta-elements of the first section of the surface of the wireless device to perform beam sweeping based on at least one of the minimum transmissive angle or the maximum transmissive angle. The method may include configuring the second transmissive coefficient of the second set of meta-elements of the second section of the surface of the wireless device to perform the beam sweeping based on at least one of the minimum incident angle or the maximum incident angle.

Aspect 11 is the method of any of aspects 1 to 10, where at least one of the transmissive signal configuration or the transmissive and reflective configuration may include a first beamforming gain factor. The method may include applying the first beamforming gain factor to at least one meta-element of the surface of the wireless device.

Aspect 12 is the method of any of aspects 1 to 11, where the method may include receiving, from the network node, a second transmissive signal configuration or a second transmissive and reflective configuration including a second beamforming gain factor. The method may include applying the second beamforming gain factor to the at least one meta-element of the surface of the wireless device. The method may include applying the second beamforming gain factor and the first beamforming gain factor to the at least one meta-element of the surface of the wireless device.

Aspect 13 is the method of any of aspects 1 to 12, where the third indication of the transmissive and reflective capability may indicate that a power split between transmission and reflection associated with a set of meta-elements of the surface of the wireless device is fixed.

Aspect 14 is the method of any of aspects 1 to 13, where the third indication of the transmissive and reflective capability may indicate that a power split between transmission and reflection associated with meta-elements of the surface of the wireless device is configurable. The transmissive and reflective configuration may include a fourth indication of a power split ratio between the transmission and the reflection. The method may include configuring a set of meta-elements of the surface of the wireless device based on the fourth indication of the power split ratio between the transmission and the reflection.

Aspect 15 is the method of any of aspects 1 to 14, where the third section and the fourth section may include an overlapping section of the surface of the wireless device. Selecting the third section of the surface of the wireless device for the transmissive mode may include selecting a first set of time periods for the overlapping section of the surface of the wireless device. Selecting the fourth section of the surface of the wireless device for the reflective mode may include selecting a second set of time periods for the overlapping section of the surface of the wireless device. The first set of time periods and the second set of time periods may be non-overlapping.

Aspect 16 is the method of any of aspects 1 to 15, where the method may include configuring at least one of a transmissive coefficient for the third section of the surface or a reflective coefficient for the fourth section of the surface based on the transmissive and reflective configuration.

Aspect 17 is the method of any of aspects 1 to 16, where the wireless device may include a RIS.

Aspect 18 is a method of wireless communication at a network node, where the method may include receiving, from a wireless device, a capability report including at least one of: (1) a first indication of a transmissive coefficient value, (2) a second indication of a sensing capability, or (3) a third indication of a transmissive and reflective capability. The method may include transmitting, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

Aspect 19 is the method of aspect 18, where the capability report may include a fourth indication of a bidirectional transmission capability. The method may include configuring at least one of the transmissive signal configuration or the transmissive and reflective configuration to overlap the first section for the first transmission direction and the second section for the second transmission direction based on the fourth indication of the bidirectional transmission capability indicating that the wireless device is capable of simultaneous bidirectional transmission. The method may include configuring at least one of the transmissive signal configuration or the transmissive and reflective configuration to split the surface of the wireless device into the first section for the first transmission direction and the second section for the second transmission direction based on the fourth indication of the bidirectional transmission capability indicating that the wireless device is not capable of the simultaneous bidirectional transmission.

Aspect 20 is the method of either of aspects 18 or 19, where the capability report may include a fourth indication of whether the transmissive coefficient value is relevant to an incident angle of a transmitted signal. The method may include configuring at least one of the transmissive signal configuration or the transmissive and reflective configuration to split the surface of the wireless device into the first section for the first transmission direction and the second section for the second transmission direction based on the fourth indication indicating that the transmissive coefficient value is relevant to the incident angle of the transmitted signal. The method may include configuring at least one of the transmissive signal configuration or the transmissive and reflective configuration to overlap the first section for the first transmission direction and the second section for the second transmission direction based on the fourth indication indicating that the transmissive coefficient value is not relevant to the incident angle of the transmitted signal.

Aspect 21 is the method of any of aspects 18 to 20, where at least one of the transmissive signal configuration or the transmissive and reflective configuration may include a fourth indication of an entire surface area of the surface of the wireless device for the first transmission direction. At least one of the transmissive signal configuration or the transmissive and reflective configuration may include a fifth indication of the first transmission direction.

Aspect 22 is the method of any of aspects 18 to 21, where at least one of the transmissive signal configuration or the transmissive and reflective configuration may include a fourth indication of at least one of an incident angle or an incident distance for the first section of the surface of the wireless device for the first transmission direction. At least one of the transmissive signal configuration or the transmissive and reflective configuration may include a fifth indication of at least one of a transmissive angle or a transmissive distance for the second section of the surface of the wireless device.

Aspect 23 is the method of aspect 22, where at least one of the transmissive signal configuration or the transmissive and reflective configuration may further include a sixth indication of at least one of a minimum transmissive angle or a maximum transmissive angle for beam sweeping a sensing signal. At least one of the transmissive signal configuration or the transmissive and reflective configuration may further include a seventh indication of at least one of a minimum incident angle or a maximum incident angle for beam sweeping the sensing signal.

Aspect 24 is the method of any of aspects 18 to 23, where at least one of the transmissive signal configuration or the transmissive and reflective configuration may include a first beamforming gain factor associated with a set of meta-elements of the surface of the wireless device.

Aspect 25 is the method of any aspect 24, where the method may include transmitting a sensing signal to the wireless device. The method may include receiving a reflected signal from the wireless device based on the transmitted sensing signal and the first beamforming gain factor. The method may include transmitting at least one of a second transmissive signal configuration or a second transmissive and reflective configuration including a second beamforming gain factor based on the received reflected signal.

Aspect 26 is the method of aspect 25, where at least one of the second transmissive signal configuration or the second transmissive and reflective configuration may include at least one of an absolute gain value or a relative gain value relative to the first beamforming gain factor.

Aspect 27 is the method of any of aspects 18 to 26, where the third indication of the transmissive and reflective capability may indicate that a power split between transmission and reflection associated with a set of meta-elements of the surface of the wireless device is configurable. The method may include configuring at least one of the transmissive signal configuration or the transmissive and reflective configuration to indicate a power split ratio between the transmission and the reflection.

Aspect 28 is the method of any of aspects 18 to 27, where the third section and the fourth section may include an overlapping section of the surface of the wireless device. The method may include configuring at least one of the transmissive signal configuration or the transmissive and reflective configuration to indicate a first set of time periods for the overlapping section of the surface of the wireless device and a second set of time periods for the overlapping section of the surface of the wireless device. The first set of time periods and the second set of time periods may be non-overlapping.

Aspect 29 is the method of any of aspects 18 to 28, where the method may include configuring at least one of the transmissive signal configuration or the transmissive and reflective configuration to indicate at least one of a transmissive coefficient for the third section of the surface or a reflective coefficient for the fourth section of the surface based.

Aspect 30 is the method of any of aspects 18 to 29, where the wireless device may include a RIS.

Aspect 31 is the method of any of aspects 8, 9, 10, 22, or 23, where the first section and the second section may overlap. For example, the same transmissive coefficient may be used for bi-directional transmission, such that a RIS may not be split into two sections in order to accommodate both redirection of a first portion of a beam and reflection of a second portion of a beam directed at a surface of the RIS.

Aspect 32 is an apparatus for wireless communication, including: a memory; and at least one processor coupled to the memory and, based at least in part on information stored in the memory, the at least one processor is configured to implement any of aspects 1 to 31.

Aspect 33 is the apparatus of aspect 31, further including at least one of an antenna or a transceiver coupled to the at least one processor.

Aspect 34 is an apparatus for wireless communication including means for implementing any of aspects 1 to 31.

Aspect 35 is a computer-readable medium (e.g., a non-transitory computer-readable medium) storing computer executable code, where the code when executed by a processor causes the processor to implement any of aspects 1 to 31.

1. An apparatus for wireless communication at a wireless device, comprising:
memory; and
at least one processor coupled to the memory and, based at least in part on information stored in the memory, the at least one processor is configured to:
transmit, for a network node, a capability report comprising at least one of: (1) a first indication of a first transmissive coefficient value, (2) a second indication of a sensing capability, or (3) a third indication of a transmissive and reflective capability;
receive, from the network node, at least one of a transmissive signal configuration or a transmissive and reflective configuration based on the capability report; and
select, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

2. The apparatus of claim 1, wherein the capability report comprises a fourth indication of whether the first transmissive coefficient value is associated with monodirectional transmission or bidirectional transmission.

3. The apparatus of claim 1, wherein the capability report comprises a fourth indication of a bidirectional transmission capability.

4. The apparatus of claim 1, wherein the first transmissive coefficient value is associated with the first transmission direction, wherein the capability report further comprises a fourth indication of a second transmissive coefficient value associated with the second transmission direction, wherein the first transmissive coefficient value is different from the second transmissive coefficient value, wherein at least one of the transmissive signal configuration or the transmissive and reflective configuration comprises a fifth indication of the first section of the surface of the wireless device for the first transmission direction and a sixth indication of the second section of the surface of the wireless device for the second transmission direction, wherein selecting the first section of the surface of the wireless device for the first transmission direction and the second section of the surface of the wireless device for the second transmission direction is based on the fifth indication and the sixth indication of at least one of the transmissive signal configuration or the transmissive and reflective configuration.

5. The apparatus of claim 1, wherein the first transmissive coefficient value is associated with the first transmission direction and the second transmission direction, wherein at least one of the transmissive signal configuration or the transmissive and reflective configuration comprises a fourth indication of an entire surface area of the surface of the wireless device for the first transmission direction and the second transmission direction, wherein the at least one processor is further configured to:
select the entire surface area of the surface of the wireless device as the first section of the surface of the wireless device for the first transmission direction and as the second section of the surface of the wireless device for the second transmission direction based on the fourth indication of at least one of the transmissive signal configuration or the transmissive and reflective configuration.

6. The apparatus of claim 1, wherein at least one of the transmissive signal configuration or the transmissive and reflective configuration comprises a fourth indication of an entire surface area of the surface of the wireless device for the first transmission direction, wherein the at least one processor is further configured to:
select the entire surface area of the surface of the wireless device as the first section of the surface of the wireless device for the first transmission direction based on the fourth indication of at least one of the transmissive signal configuration or the transmissive and reflective configuration.

7. The apparatus of claim 6, wherein at least one of the transmissive signal configuration or the transmissive and reflective configuration further comprises a fifth indication of the first transmission direction, wherein, to select the first section of the surface of the wireless device for the first transmission direction, the at least one processor is configured to:
select the first section of the surface of the wireless device for the first transmission direction based on the fifth indication of at least one of the transmissive signal configuration or the transmissive and reflective configuration.

8. The apparatus of claim 1, wherein at least one of the transmissive signal configuration or the transmissive and reflective configuration comprises a fourth indication of at least one of an incident angle or an incident distance for the first section of the surface of the wireless device for the first transmission direction and a fifth indication of at least one of a transmissive angle or a transmissive distance for the second section of the surface of the wireless device, wherein the at least one processor is further configured to:
configure a first transmissive coefficient of a first set of meta-elements of the first section of the surface of the wireless device based on the fourth indication of at least one of the incident angle or the incident distance; and
configure a second transmissive coefficient of a second set of meta-elements of the second section of the surface of the wireless device based on the fifth indication of at least one of the transmissive angle or the transmissive distance.

9. The apparatus of claim 8, wherein the incident angle is equal to the transmissive angle.

10. The apparatus of claim 8, wherein at least one of the transmissive signal configuration or the transmissive and reflective configuration further comprises a sixth indication of at least one of a minimum transmissive angle or a maximum transmissive angle and a seventh indication of at least one of a minimum incident angle or a maximum incident angle, wherein the at least one processor is further configured to:
configure the first transmissive coefficient of the first set of meta-elements of the first section of the surface of the wireless device to perform beam sweeping based on at least one of the minimum transmissive angle or the maximum transmissive angle; and
configure the second transmissive coefficient of the second set of meta-elements of the second section of the surface of the wireless device to perform the beam sweeping based on at least one of the minimum incident angle or the maximum incident angle.

11. The apparatus of claim 1, wherein at least one of the transmissive signal configuration or the transmissive and reflective configuration comprises a first beamforming gain factor, wherein the at least one processor is further configured to:
apply the first beamforming gain factor to at least one meta-element of the surface of the wireless device.

12. The apparatus of claim 11, wherein the at least one processor is further configured to:
receive, from the network node, a second transmissive signal configuration or a second transmissive and reflective configuration comprising a second beamforming gain factor; and
apply at least one of the second beamforming gain factor or the second beamforming gain factor and the first beamforming gain factor to the at least one meta-element of the surface of the wireless device.

13. The apparatus of claim 1, wherein the third indication of the transmissive and reflective capability indicates that a power split between transmission and reflection associated with a set of meta-elements of the surface of the wireless device is fixed.

14. The apparatus of claim 1, wherein the third indication of the transmissive and reflective capability indicates that a power split between transmission and reflection associated with meta-elements of the surface of the wireless device is configurable, wherein the transmissive and reflective configuration comprises a fourth indication of a power split ratio between the transmission and the reflection, wherein the at least one processor is further configured to:
configure a set of meta-elements of the surface of the wireless device based on the fourth indication of the power split ratio between the transmission and the reflection.

15. The apparatus of claim 1, wherein the third section and the fourth section comprise an overlapping section of the surface of the wireless device, wherein, to select the third section of the surface of the wireless device for the transmissive mode, the at least one processor is configured to select a first set of time periods for the overlapping section of the surface of the wireless device, wherein, to select the fourth section of the surface of the wireless device for the reflective mode, the at least one processor is configured to select a second set of time periods for the overlapping section of the surface of the wireless device, wherein the first set of time periods and the second set of time periods are non-overlapping.

16. The apparatus of claim 1, wherein the at least one processor is further configured to:
configure at least one of a transmissive coefficient for the third section of the surface or a reflective coefficient for the fourth section of the surface based on the transmissive and reflective configuration.

17. The apparatus of claim 1, further comprising a transceiver coupled to the at least one processor, wherein the at least one processor is configured to transmit the capability report via the transceiver, wherein the wireless device comprises a reconfigurable intelligent surface (RIS).

18. An apparatus for wireless communication at a network node, comprising:
memory; and
at least one processor coupled to the memory and, based at least in part on information stored in the memory, the at least one processor is configured to:
receive, from a wireless device, a capability report comprising at least one of: (1) a first indication of a transmissive coefficient value, (2) a second indication of a sensing capability, or (3) a third indication of a transmissive and reflective capability; and
transmit, for the wireless device based on the capability report, at least one of a transmissive signal configuration or a transmissive and reflective configuration associated with at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

19. The apparatus of claim 18, wherein the capability report comprises a fourth indication of a bidirectional transmission capability, wherein the at least one processor is further configured to:
configure at least one of the transmissive signal configuration or the transmissive and reflective configuration to overlap the first section for the first transmission direction and the second section for the second transmission direction based on the fourth indication of the bidirectional transmission capability indicating that the wireless device is capable of simultaneous bidirectional transmission; and
configure at least one of the transmissive signal configuration or the transmissive and reflective configuration to split the surface of the wireless device into the first section for the first transmission direction and the second section for the second transmission direction based on the fourth indication of the bidirectional transmission capability indicating that the wireless device is not capable of the simultaneous bidirectional transmission.

20. (canceled)

21. (canceled)

22. (canceled)

23. (canceled)

24. (canceled)

25. (canceled)

26. (canceled)

27. (canceled)

28. (canceled)

29. A method of wireless communication at a wireless device, comprising:
transmitting, for a network node, a capability report comprising at least one of: (1) a first indication of a first transmissive coefficient value, (2) a second indication of a sensing capability, or (3) a third indication of a transmissive and reflective capability;
receiving, from the network node, at least one of a transmissive signal configuration or a transmissive and reflective configuration based on the capability report; and
selecting, based on at least one of the transmissive signal configuration or the transmissive and reflective configuration, at least one of: (1) a first section of a surface of the wireless device for a first transmission direction, (2) a second section of the surface of the wireless device for a second transmission direction, (3) a third section of the surface of the wireless device for a transmissive mode, or (4) a fourth section of the surface of the wireless device for a reflective mode.

30. (canceled)
